(19) United States
(12) Patent Application Publication
(10) Pub. No.: US 2014/0066291 A1
(43) Pub. Date: Mar. 6, 2014

(54) MATERIALS AND METHODS FOR IMPROVING SELECTIVITY IN HETEROGENEOUS CATALYSTS AND PRODUCTS THEREOF

(71) Applicants: Stephen Marshall, Bartlesville, OK (US); James William Medlin, Boulder, CO (US); Daniel K. Schwartz, Boulder, CO (US)

(72) Inventors: Stephen Marshall, Bartlesville, OK (US); James William Medlin, Boulder, CO (US); Daniel K. Schwartz, Boulder, CO (US)

(73) Assignee: The Regents of The University of Colorado, a body corporate, Denver, CO (US)

(21) Appl. No.: 13/983,133

(22) PCT Filed: Feb. 1, 2012
(86) PCT No.: PCT/US12/23520

§ 371 Date: Nov. 13, 2013

Related U.S. Application Data
(60) Provisional application No. 61/438,473, filed on Feb. 1, 2011.

(51) Int. Cl. B01J 31/26

(52) U.S. Cl. CPC B01J 31/26
USPC 502/168

(57) ABSTRACT

Methods for improving selectivity in heterogeneous catalysts, and products thereof, are disclosed. In exemplary embodiments, multifunctional oxygenates may be selectively converted to value-added products through reaction at a single functional position. Addition of a self-assembled monolayer (SAM), or SAM-like structures to a supported metal catalyst is also disclosed.

### CROSS-REFERENCE

This application claims the benefit of U.S. Provisional Application No. 61/438,473, filed Feb. 1, 2011, which is incorporated herein by reference in its entirety.

### BACKGROUND OF THE INVENTION

Heterogeneous catalysts are widely used in industrial processes due to their stability and ease of separation from the reactant phase compared to their homogeneous counterparts. One continual challenge in their development is the improvement of selectivity, which can significantly reduce costs of product purification and waste. In contrast to their heterogeneous counterparts, homogeneous catalysts commonly offer high selectivities through specific interactions between functional groups on the catalyst and reactant. For example, enzymes are able to achieve high selectivity through selective interactions of a reactant and amino acid residues near the active site. Similarly, synthetic homogeneous catalysts engineered through the modification of porphyrin are highly selective for chiral epoxidation and reactions of proteins and aromatics. Similar results may also be achieved for the selective binding of chiral molecules on single crystal metal surfaces. However, heterogeneous catalysts employing these principles are lacking. Therefore, it is still desired to develop a heterogeneous catalyst utilizing specific interactions to promote high selectivity.

### SUMMARY OF THE INVENTION

Techniques are disclosed herein for improving selectivity in heterogeneous catalysts. Based on the specific interactions that confer high selectivity in homogeneous systems, certain embodiments of the disclosed techniques employ self-assembled monolayers as a novel platform for surface modification of supported metal catalysts (see for example, FIG. 1). These catalyst coatings greatly improve selectivity, for example, for hydrogenation of the olefin functionality of epoxybutene over reaction of the epoxide functionality, an important yet difficult reaction for the production of value added chemicals. The techniques also include selectivity and activity of catalysts coated with alkanethiols of different tail lengths.

In one aspect, provided herein is a supported metal catalyst comprising sulfur and/or selenium on the surface of the metal, wherein at least 70% of the sulfur and/or selenium is in the (√3×√3)R30 geometry.

In some embodiments, at most 10% of the sulfur and/or selenium is in the (√7×√7)R19 geometry.

In some embodiments, the sulfur and/or selenium is bound to a hydrocarbon tail.

In some embodiments, the sulfur and/or selenium is coated on the surface of the metal as substantially a self-assembled monolayer (SAM).

In some embodiments, the sulfur and/or selenium covers at least 80% of the surface of the metal.

In one aspect, provided herein is a supported metal catalyst comprising a monolayer coating of molecules, the molecules comprising a head group bound to a hydrocarbon tail.

In some embodiments, the head group comprises a thiol, a selenide, a disulfide, or a diselenide.

In some embodiments, the molecules cover at least 80% of the surface of the metal.

In some embodiments, the metal is a transition metal.

In some embodiments, the metal is platinum, palladium, rhodium, ruthenium, osmium, iridium, nickel, copper, silver, or gold.

In some embodiments, the surface of the metal is face-centered cubic (111).

In some embodiments, the metal is supported on carbon, alumina, silica, zinc oxide, tungsten oxide, or titanium dioxide.

In some embodiments, the catalyst is PdAl₂O₃ comprising an alkanethiol monolayer.

In some embodiments, the hydrocarbon tail comprises at least 3 carbon atoms, at least 6 carbon atoms, at least 12 carbon atoms, or at least 18 carbon atoms.

In some embodiments, the hydrocarbon tail comprises at least 12 carbon atoms.

In some embodiments, the hydrocarbon tail further comprises alkenes, alcohols, acids, amines, or aromatics.

In some embodiments, the catalyst further comprises a thioglycerol coating.

In one aspect, provided herein is a supported metal catalyst capable of selectively reducing a carbon-carbon bond in preference to an oxygenate group, wherein the selectivity for the carbon-carbon bond is at least about 80% at a conversion of at least 5%.

In some embodiments, the oxygenate group is selected from an epoxide, an aldehyde, an acid, a nitrile, an alkyne, and any combination thereof.

In one aspect, provided herein is a supported metal catalyst capable of selectively hydrogenating a single functional group of a polyfunctional molecule.

In some embodiments, the polyfunctional molecule comprises an olefin group and at least one group selected from an epoxide, an aldehyde, an acid, a nitrile, and an alkyne.

In some embodiments, the selectively hydrogenated functional group is an olefin group.

In some embodiments, the polyfunctional molecule is derived from biomass.

In some embodiments, the polyfunctional molecule is 3,4-epoxy-1-butene (EpB), crotonaldehyde, itaconic acid, levulinic acid, 2,5-furandicarboxylic acid, or fumaric acid.

In some embodiments, the selectivity for hydrogenation of the olefin is at least about 80% at a conversion of at least 5%.

In one aspect, provided herein is a supported metal catalyst comprising a selectivity agent, wherein the catalyst is capable of (a) selectively hydrogenating an olefin at a yield of at least 60%; and (b) hydrogenating the olefin with a turnover frequency of at least 40% when compared with the turnover frequency with the metal catalyst without the selectivity agent.

In some embodiments, the selectivity agent comprises a hydrocarbon tail and at least one of a thiol, a selenide, a disulfide, and a diselenide.

In some embodiments, the selectivity is measured in the gas phase.

In some embodiments, the selectivity is measured in the liquid phase.

In one aspect, described herein is a supported metal catalyst comprising an alkanethiol self-assembled monolayer, wherein the catalyst is capable of selectively hydrogenating acetylene in a mixture of acetylene and ethylene.

In some embodiments, the mixture of acetylene and ethylene comprises between about 0.5% and 3% acetylene.

In some embodiments, the catalyst is capable of reducing the acetylene concentration to less than 5 ppm in the mixture.

In some embodiments, the ethylene is not substantially hydrogenated to ethane.

In some embodiments, the selective hydrogenation of acetylene is capable of being achieved without addition of carbon monoxide to the mixture.

In some embodiments, the alkanethiol comprises at least 18 carbon atoms.

In some embodiments, the activity of the supported metal catalyst comprising an alkanethiol self-assembled monolayer for acetylene hydrogenation is at least 80% of the activity of the supported metal catalyst without the alkanethiol self-assembled monolayer.

In one aspect, provided herein is a method for producing a selective catalyst, the method comprising: (a) providing a supported metal catalyst; (b) coating the catalyst with a molecule, wherein the molecule comprises a hydrocarbon tail and at least one of a thiol, a selenide, a disulfide, and a diselenide.

In some embodiments, the molecule is propanethiol (C3), hexanethiol (C6), dodecanethiol (C12), or octadecanethiol (C18).

In some embodiments, the method further comprises coating the catalyst with thioglycerol.

In one aspect, provided herein is a method for producing a selective catalyst, the method comprising: (a) providing a supported metal catalyst; (b) oxidizing the catalyst; (c) reducing the catalyst; (d) immersing the catalyst in a solution comprising a molecule, wherein the molecule comprises a hydrocarbon tail and at least one of a thiol, a selenide, a disulfide, and a diselenide.

In some embodiments, the catalyst is oxidized in a 20% O₂ environment for about 2 hours.

In some embodiments, the catalyst is reduced in a 20% H₂ environment for at least 4 hours.

In some embodiments, the molecule has a concentration in the solution of less than about 1 M.

In some embodiments, the molecule has a concentration in the solution between about 0.01 M and 0.1 M.

In some embodiments, the catalyst is immersed for between about 12 hours and 48 hours.

In some embodiments, the method further comprises coating the catalyst with thioglycerol.

In one aspect, provided herein is a method for selectively hydrogenating a polyfunctional feedstock, the method comprising: (a) providing a feedstock, wherein the feedstock comprises a plurality of chemical functionalities; (b) providing a supported metal catalyst coated with a molecule, wherein the molecule comprises a hydrocarbon tail and at least one of a thiol, a selenide, a disulfide, and a diselenide; and (c) contacting the feedstock with the catalyst.

In some embodiments, the hydrocarbon tail comprises at least 12 carbon atoms.

In some embodiments, the molecule is propanethiol (C3), hexanethiol (C6), dodecanethiol (C12), or octadecanethiol (C18).

In some embodiments, the feedstock is a gas.

In some embodiments, the feedstock is a liquid.

In some embodiments, the liquid comprises heptane and thioglycerol.

In some embodiments, the liquid further comprises 3,4-epoxy-1-butene (EpB).

In some embodiments, the method further comprises coating the catalyst with thioglycerol.

In some embodiments, the feedstock comprises at least one olefin functionality, wherein the olefin functionality is selectively hydrogenated.

In some embodiments, the temperature is such that at least one chemical functionality of the feedstock is hydrogenated and the coating is not substantially desorbed or degraded.

In some embodiments, the contacting step is performed at a temperature between about 313 K and 333 K.

In some embodiments, the rate of hydrogenation using the coated catalyst is at least about 70% of the rate of hydrogenation using a non-coated catalyst.

In some embodiments, the polyfunctional feedstock is derived from biomass.

In some embodiments, the polyfunctional feedstock comprises 3,4-epoxy-1-butene (EpB), crotonaldehyde, itaconic acid, levulinic acid, 2,5-furandicarboxylic acid, or fumaric acid.

In some embodiments, the polyfunctional feedstock comprises 3,4-epoxy-1-butene (EpB), and wherein the contacting with the catalyst results in epoxybutane.

In some embodiments, the method further comprises converting the epoxybutane to at least one of a polyether, surfactant, glycol, polyester, epoxy resin, and fuel additive.

In some embodiments, at least 30% of the 3,4-epoxy-1-butene (EpB) is converted to epoxybutane.

In some embodiments, the polyfunctional feedstock comprises crotonaldehyde, and wherein the contacting with the catalyst results in butyraldehyde at a yield of at least 80% and a conversion of at least 50%.

In some embodiments, the polyfunctional feedstock comprises a mixture of acetylene and ethylene, and wherein the contacting with the catalyst results in selective reduction of the acetylene.

In some embodiments, contacting polyfunctional feedstock with the catalyst produces an ethylene product, wherein the ethylene product has a concentration of acetylene below 5 ppm.

In some embodiments, contacting polyfunctional feedstock with the catalyst reduces acetylene at a rate that is at least 1,000 times faster than the rate of ethylene reduction.

In one aspect, provided herein is a method for selectively hydrogenating acetylene in a mixture comprising acetylene and ethylene, the method comprising: (a) providing a feedstock, wherein the feedstock comprises a mixture comprising acetylene and ethylene; (b) providing a supported metal catalyst coated with a molecule, wherein the molecule comprises a hydrocarbon tail and at least one of a thiol, a selenide, a disulfide, and a diselenide; and (c) contacting the feedstock with the catalyst.

In some embodiments, contacting feedstock with the catalyst produces an ethylene product, wherein the ethylene product has a concentration of acetylene below 5 ppm.

In some embodiments, contacting feedstock with the catalyst reduces acetylene at a rate that is at least 1,000 times faster than the rate of ethylene reduction.

In one aspect, provided herein is the epoxybutane produced by the methods described herein.

In one aspect, provided herein is the butyraldehyde produced by the methods described herein.

In one aspect, provided herein is the ethylene product produced by the methods described herein.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an illustration of an exemplary thiol self-assembled monolayer (SAM) coating on Pd.

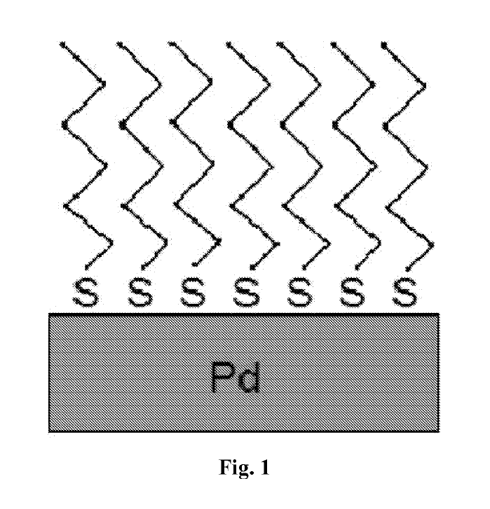

FIG. 2 is a plot of selectivity to Epoxybutane versus Tail Length for various exemplary alkanethiol coatings.

FIG. 3 is a plot of Rate versus Tail Length for an exemplary alkanethiol coated 5% Pd/Al₂O₃.

FIG. 4 is a plot of diffuse reflectance infrared Fourier transform spectroscopy (DRIFTS) and Expected Modes for an exemplary octadecanethiol SAM adsorbed on 5% Pd/Al₂O₃.

FIG. 5 is a temperature programmed desorption (TPD) spectra for an exemplary EpB adsorbed on Pd(111) at 173 K.

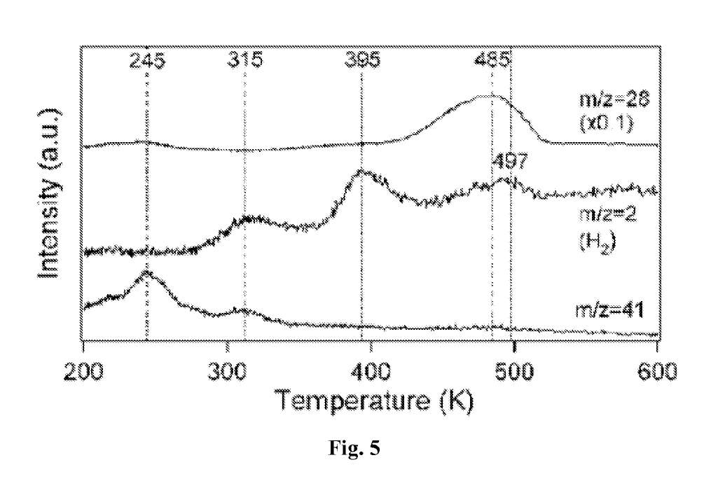

FIG. 6 is a high resolution electron energy loss (HREEL) spectra collected after (a) adsorption of EpB at 140 K, and subsequent annealing to (b) 190 K, (c) 250 K, and (d) 350 K.

FIG. 7 is a TPD spectra for EpB and similar oxygenates on hexanethiol SAM Coated Pd(111).

FIG. 8 shows reaction pathways of epoxybutene (i.e., derivative tree) on palladium catalysts.

FIG. 9 shows the primary reaction products for epoxybutene hydrogenation on uncoated metal catalysts versus on metal catalysts coated with SAMs as described herein.

FIG. 10 is an illustration of an exemplary thiol (propanethiol) SAM coating on Pd(111) in the (√3×√3)R30 geometry.

FIG. 11 is a space filling model shown from above which illustrates the space available for reaction on the surface of an exemplary catalyst (propanethiol coated on Pd(111) in the (√3×√3)R30 geometry).

FIG. 12 depicts the sequential hydrogenation of acetylene (left) to ethylene (center) to ethane (right).

FIG. 13 depicts the epoxybutane selectivity (left axis) and formation rate (right axis) for different thiol coatings at 313 K (C3=propanethiol, C6=hexanethiol, C12=dodecanethiol, C18=octadecanethiol, C3OH=1-mercapto-3-propanol, C6OH=1-mercapto-6-hexanol, TG=thioglycerol).

FIG. 14 is a plot of diffuse reflectance infrared Fourier transform spectroscopy (DRIFTS) for exemplary alkanethiol SAMs.

FIG. 15 is an example of the effect of CO feed concentration on epoxybutane selectivity and EpB conversion on uncoated 5% Pd/Al₂O₃ at 313 K and a 10:1 H₂ to EpB feed ratio.

FIG. 16 is a temperature programmed desorption (TPD) spectra for an exemplary EpB adsorbed on hexanethiol SAM coated Pd(111).

FIG. 17 is a plot of selectivity versus time for 4.0 mg of uncoated and C18 coated surfaces.

FIG. 18 is a plot of selectivity to ethylene during acetylene hydrogenation on C18 coated and uncoated surfaces.

FIG. 19 is a plot of conversion versus selectivity for coated and uncoated samples after 17 hours of acetylene exposure.

FIG. 20 is a depiction of DRIFTS spectra for C18 coated surfaces before and after hydrogenation reactions with the dashed and dotted lines indicating the positions of the symmetric methyl and asymmetric methylene stretches, respectively.

FIG. 21 is a depiction of an exemplary liquid phase sampling apparatus.

FIG. 22 is a plot of selectivity to epoxybutane in the gas and liquid phase for SAM coated and uncoated Pd catalysts.

FIG. 23 is a plot of selectivity to epoxybutane in the liquid phase for SAM coated and uncoated Pd catalysts, optionally including thioglycerol coating.

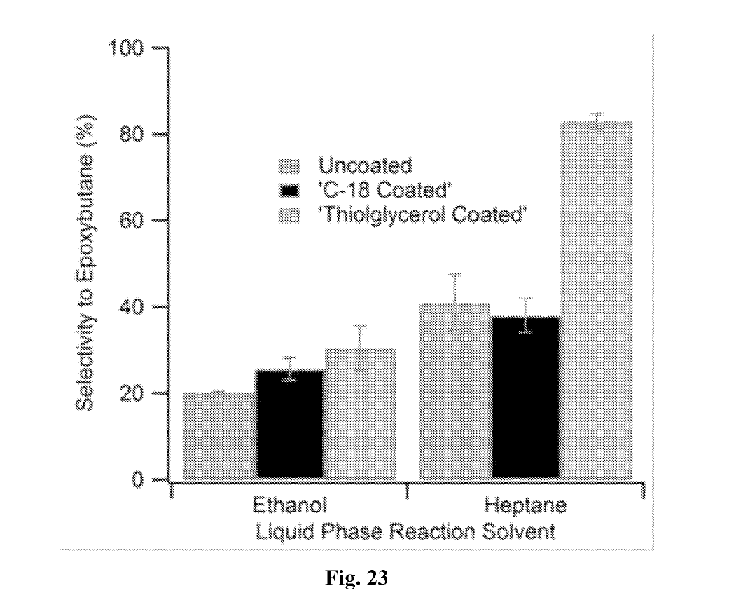

FIG. 24 depicts the gas phase hydrogenation of EpB on platinum and palladium catalysts, optionally coated with an octadecanethiol SAM.

### DETAILED DESCRIPTION OF THE INVENTION

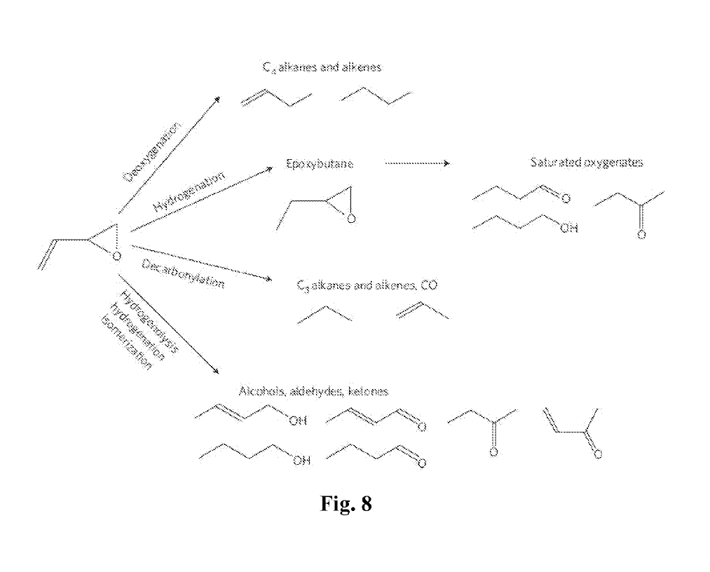

Heterogeneous catalysis for biorefining and petrochemical applications presents a number of interesting challenges. One difficulty is designing surfaces for selective conversion of a single functional group in a multifunctional-group molecule. For example, the production of high-value chemical products from many of the carbohydrates identified as the top chemicals from biomass requires the selective reduction of a carbon-carbon double bond while retaining the oxygenate functionality of the molecule (or vice versa). Such conversions are desired for reactions in the “derivative trees” of crotonaldehyde, itaconic acid, levulinic acid, 2,5-furandicarboxylic acid, and fumaric acid, among others. For example, a derivative tree of epoxybutene is shown in FIG. 8. A major complication in catalyst development efforts is that metals which traditionally show excellent C═C hydrogenation activity (e.g., Pt and Pd) are also reactive toward oxygen-containing functional groups.

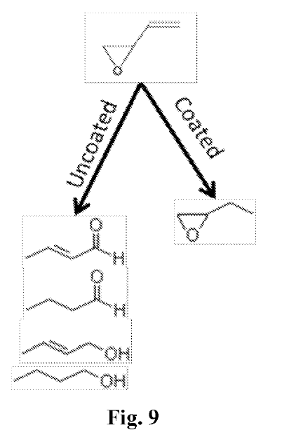

Mechanisms and materials are described herein by which multifunctional oxygenates may be selectively converted to value-added products through reaction at a single functional position. Addition of a self-assembled monolayer (SAM), or SAM-like structures to a supported metal catalyst enhances, for example, the preferential reaction of an olefin functionality over an oxygenate functionality. Materials used to form SAMs and SAM-like structures on surfaces include, but are not limited to thiols, selenides or disulfides or diselenides having hydrocarbon tails. FIG. 9 depicts the change in reaction specificity for the reaction of epoxybutene on supported metal catalysts coated with SAMs as described herein.

### Self-Assembled Monolayers

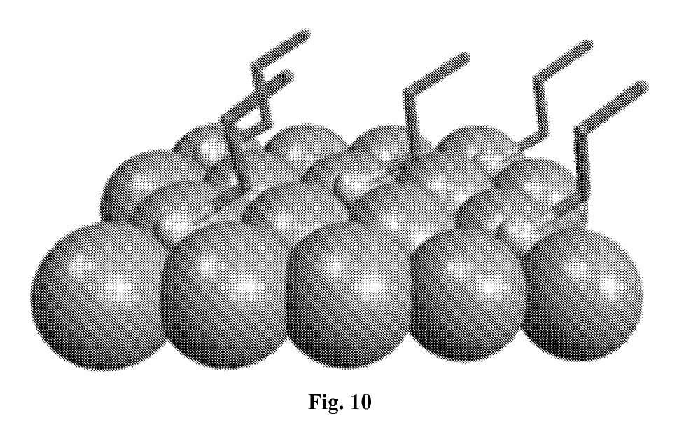

Materials, systems and methods are disclosed herein for improving selectivity in heterogeneous catalysts. In one embodiment, the techniques employ thiol self-assembled monolayers as a platform for surface modification of supported palladium catalysts. For example, FIG. 10 depicts propane thiol deposited on Pd(111) as a self-assembled monolayer. These thiol-modified catalysts greatly improve selectivity for hydrogenation of olefin functionality of, for example, epoxybutene over reaction of epoxide functionality, an important yet difficult reaction for the production of value added chemicals.

In the scientific literature, self-assembled monolayer (“SAM”) commonly refers to a structure formed solely through metal-sulfur bonds with the hydrocarbon tails protruding at an angle from the metal surface. The thiol-coated catalysts described herein may be dominated by these structures, but may also include some defects (e.g., metal-carbon bonds formed from intact thiols lying flat on the metal surface). Therefore, as used herein the term self-assembled monolayer (or “SAM”) includes SAM-like layers (i.e., even if a complete, well-organized self-assembled monolayer is not formed on the supported catalysts). That is, SAM-like materials have a layer of organic ligands that are covalently attached to the surface, but may or may not be well organized. Furthermore, the term “substantially a self-assembled monolayer” includes SAM-like layers having any suitable quantity, type, or arrangement of defects. For purposes of illustration, SAM-like structures include thiols, selenides, disulfides, or diselenides adsorbed on the catalyst surface through metal-sulfur bonds, metal-selenium bonds, or metal-carbon bonds.

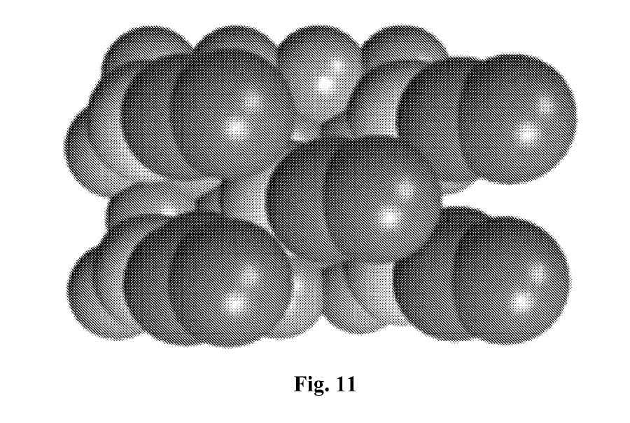

In one embodiment, described herein are catalysts and the use of catalysts comprising a monolayer (e.g., self assembled monolayer) of molecules, where the molecules comprise a head group bound to a hydrocarbon tail. The head group can be any group comprising sulfur and/or selenium (e.g., a thiol, a selenide, a disulfide, or a diselenide). The molecules (and/or sulfur or selenium) can cover any suitable proportion of the surface of the metal. In some embodiments, the molecules (and/or sulfur or selenium) cover about 70%, about 80%, about 90%, about 95%, about 99% of the surface of the metal. In some embodiments, the molecules (and/or sulfur or selenium) cover at least 70%, at least 80%, at least 90%, at least 95%, at least 99% of the surface of the metal. The term “covering” can mean that either (a) a certain portion of the metal surface is sterically blocked by the coating or (b) a certain portion of the sites available for binding of the molecules comprising the coating are in fact occupied by the coating molecules. FIG. 11 shows an example of the space available for reaction on the surface of a Pd(111) catalyst coated with propanethiol.

In one embodiment, to impart the high selectivity to heterogeneous supported metal catalysts, a palladium catalyst is modified with a thiol coating. Thiols include compounds of sulfur having a hydrocarbon tail. When deposited on a metal surface from a dilute solution (e.g., about <1 M), these thiols can spontaneously arrange to form a self-assembled monolayer (SAM), for example, as illustrated in FIG. 10. The large variety of thiols available enables tailoring specific interactions around the adsorbed reactant, (e.g., similarly to the variety of amino acids in enzymes).

It is further described herein that the geometry by which the sulfur and/or selenium is coated on the metal catalyst at least in part determines whether the sulfur and/or selenium is a poison to the catalyst or promotes selectivity of the catalyst as described herein.

In some embodiments, described herein are catalysts and use of catalysts comprising sulfur and/or selenium on the surface of a metal, wherein the sulfur and/or selenium is in the (√3×√3)R30 geometry (e.g., FIG. 10). Any suitable proportion of the sulfur and/or selenium can be in the (√3×√3)R30 geometry, including about 60%, about 70%, about 80%, about 90%, about 95%, about 99%, about 99.5%, about 99.9%, and the like. In some embodiments, the proportion of the sulfur and/or selenium in the (√3×√3)R30 geometry is at least 60%, at least 70%, at least 80%, at least 90%, at least 95%, at least 99%, at least 99.5%, at least 99.9%, and the like. Spectroscopic methods may be used to determine the geometry of the sulfur and/or selenium on the surface of the metal as is known in the art.

In some embodiments, a low amount of the sulfur and/or selenium is in the (√7×√7)R19 geometry. Any suitably low proportion of the sulfur and/or selenium can be in the (√7×√7)R19 geometry, including about 20%, about 10%, about 5%, about 1%, about 0.5%, about 0.1%, and the like. In some embodiments, proportion of the sulfur and/or selenium in the (√7×√7)R19 geometry is at most 20%, at most 10%, at most 5%, at most 1%, at most 0.5%, at most 0.1%, and the like.

Any suitable method for achieving the (√3×√3)R30 geometry of the sulfur and/or selenium on the catalyst surface is encompassed by the present invention. One suitable method is to bind a hydrocarbon tail to the sulfur and/or selenium. Without being bound by any particular theory, the attachment of the hydrocarbon tail prevents the sulfur and/or selenium from penetrating into the metal catalyst and disrupting the electronic structure and/or activity thereof.

In some embodiments, the sulfur and/or selenium head group covalently binds to the metal surface. In some embodiments, this bond is strong enough such that the SAM remains bound to the surface when the catalyst is contacted with reactants under reaction conditions (e.g., temperature). In some embodiments, the bond between the sulfur and/or selenium head group and the metal surface is such that the molecules can form a self-assembled monolayer.

### Catalyst and Carbon Tail Composition

Supported metal catalysts include particles of transition metals, such as platinum, palladium, rhodium, ruthenium, osmium, iridium, nickel, copper, silver, or gold, embedded in a high surface material such as carbon, alumina, silica, zinc oxide, tungsten oxide, or titanium dioxide. Any combination of metal and high surface material (i.e., support) is suitable, including for example PdAl₂O₃. The metal atoms can be arranged in any suitable way and/or any suitable face of the metallic material may be used (including a mixture of different faces and/or metal atom arrangements). In one non-limiting embodiment, the surface of the metal is face-centered cubic, as represented by the notation (111) known to those skilled in the art.

In some embodiments, the sulfur and/or selenium (i.e., head groups of the SAM coating molecule) is bound to a hydrocarbon tail. In some embodiments, the hydrocarbon tail allows the sulfur and/or selenium to coat the metal catalyst with the desired geometry. In some embodiments, the hydrocarbon tail interacts with the reactants and/or products of the reaction to confer enhanced rate and/or enhanced reaction specificity. In some embodiments, the hydrocarbon tails catalyze a reaction, optionally the same reaction catalyzed by the metal surface or a different reaction than is catalyzed by the metal surface. In some embodiments, the hydrocarbon tails present the reactants and/or products to the metal surface in a desired orientation. In some embodiments, the hydrocarbon tails modify the charge distribution on the metal surface in a desired manner. In some embodiments, the hydrocarbon tails cover a portion of the metal surface, optionally limiting the ensemble size of the reactants and/or products.

The hydrocarbon tails can have any suitable size, shape and chemical functionality. In some embodiments, the hydrocarbon tail comprises 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more carbon atoms. In some embodiments, the hydrocarbon tail comprises at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, or more carbon atoms.

In some embodiments, the hydrocarbon tails are sufficiently long and/or spaced sufficiently close to each other such that they form a self-assembled monolayer in which the tails are sterically and/or electrostatically prevented from laying down on the metal catalyst surface. In some embodiments, hydrocarbon tails comprising more than 12 carbon atoms are preferred.

The hydrocarbon tails include, but are not limited to alkanes of the formula CₙH₂ₙ₊₂, where n is an integer greater than or equal to one. Tail groups may also include alkenes, alkynes, alcohols, acids, amines, and aromatics, to name only a few examples. The hydrocarbon tails can have atoms other than hydrogen and carbon (e.g., nitrogen, oxygen). In some embodiments, the molecules coating the metal catalyst are amphiphilic (i.e., comprises hydrophobic portions and hydrophilic portions). The catalysts and use of catalysts described herein can have a single type of hydrocarbon tail, or may have a plurality of types of hydrocarbon tail.

### Further Coatings

In some embodiments, the catalyst is further coated with a second molecule in addition to the self-assembled monolayer described herein. The secondary coating can have any suitable thickness and need not be a monolayer. The secondary coating can be any material suitable for enhancing the rate and/or specificity of the reaction being catalyzed by the catalyst described herein. In some embodiments, the secondary coating comprises sulfur and/or selenium atoms, optionally attached to hydrocarbon tails. In one embodiment, the secondary coating is thioglycerol.

### Performance of the Selective Catalyst

Supported metal catalysts not modified as described herein generally exhibit low selectivity (e.g., selectivity for olefin hydrogenation in preference to hydrogenation of other oxygenate groups). In some embodiments, low selectivity is due to the tendency of certain functionalities (e.g., oxygenate groups) to decompose on the metal surface. Thus, the performance of the catalysts and use of the catalysts described herein can be compared with the performance of the catalysts without said modification (e.g., PdAl₂O₃ modified with an alkanethiol SAM compared with PdAl₂O₃).

In one aspect, described herein is a metal catalyst capable of selectively reducing a carbon-carbon bond in preference to an oxygenate group. In various embodiments, the oxygenate group can be selected from an epoxide, an aldehyde, an acid, a nitrile, an alkyne, and any combination thereof. The preference for carbon-carbon bond reduction need not be 100%. In some embodiments, it is less than 100%, such as about 90%, about 80%, about 70%, and the like. The carbon-carbon bond can be on the same molecule as the oxygenate group, or on different molecules (i.e., the feedstock comprises a mixture of molecules).

In one aspect, there is a need for catalysts that can selectively hydrogenate a single functional group on a polyfunctional molecule. “Functional groups” are well known to those skilled in the chemical arts and include olefins, alcohols, acids, nitriles, esters, epoxides, and the like. The polyfunctional molecule therefore comprises at least two functional groups. In some embodiments, the polyfunctional molecule comprises an olefin group, optionally with at least one epoxide, aldehyde, acid, nitrile, and/or alkyne. Polyfunctional molecules can be derived from biomass in some embodiments. Exemplary polyfunctional molecules include 3,4-epoxy-1-butene (EpB), crotonaldehyde, itaconic acid, levulinic acid, 2,5-furandicarboxylic acid, and fumaric acid. In some embodiments, it is an olefin group that is selectively hydrogenated.

In some embodiments, provided herein are supported metal catalysts comprising a selectivity agent, wherein the catalyst is capable of selectively hydrogenating an olefin, and wherein the catalyst is capable of hydrogenating the olefin with a high turnover frequency compared with the metal catalyst without the selectivity agent. In some embodiments, the selectivity agent comprises a hydrocarbon tail and at least one of a thiol, a selenide, a disulfide and a diselenide.

The selectivity for hydrogenation of the olefin over another chemical group (e.g., an oxygenate group such as an epoxide) can be any suitable value. The selectivity can be measured under any suitable condition including any conversion, any temperature, and the like. The selectivity can be measured in the gas phase, the liquid phase, or the supercritical phase, in various embodiments. As used herein, selectivity is the ratio of the rate of olefin hydrogenation to the rate of hydrogenation of all chemical group(s), including the olefin group. Selectivity ranges from 0% to 100%. In some embodiments, the selectivity is about 60%, about 70%, about 80%, about 90%, about 95%, about 99%, and the like. In some embodiments, the selectivity is at least 60%, at least 70%, at least 80%, at least 90%, at least 95%, at least 99%, and the like.

In one aspect, the catalysts described herein achieve high selectivity without a substantial loss in activity. In some embodiments, the turnover frequency (i.e., rate) of olefin hydrogenation with the catalyst comprising the selectivity agent is about 10%, about 20%, about 30%, about 40%, about 50%, about 60%, about 70%, about 80%, about 90%, and the like of the rate of olefin hydrogenation with the catalyst without the selectivity agent. In some embodiments, the turnover frequency (i.e., rate) of olefin hydrogenation with the catalyst comprising the selectivity agent is at least 10%, at least 20%, at least 30%, at least 40%, at least 50%, at least 60%, at least 70%, at least 80%, at least 90%, and the like of the rate of olefin hydrogenation with the catalyst without the selectivity agent.

In one aspect, the selectivity (e.g., for hydrogenation of an olefin) and/or rates (e.g., turnover frequency for olefin hydrogenation) achieved by the catalysts and methods described herein are achieved at a high conversion. Conversion, selectivity and yield are related by the formula (yield)=(conversion)×(selectivity). For example, if 90% of the substance “A” is transformed into another material (i.e., reacts on the catalyst, including being transformed into the desired product and/or an undesired product), then the conversion is 90%. If 80% of the substance “A” that is converted (i.e., reacts) is transformed into desired product “B”, then the selectivity is 80%. The yield for desired substance “B” can be obtained by multiplying 90%×80%, the result being 72%.

The conversion can be any suitable value. In some embodiments, the conversion is about 5%, about 10%, about 15%, about 20%, about 30%, about 40%, about 50%, about 60%, about 70% and the like. In some embodiments, the conversion is at least 5%, at least 10%, at least 15%, at least 20%, at least 30%, at least 40%, at least 50%, at least 60%, at least 70% and the like.

### Catalyst for the Selective Hydrogenation of Acetylene

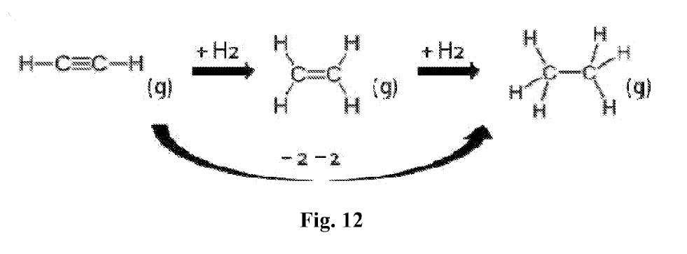

The selective hydrogenation of acetylene is an important industrial process for the purification of ethylene. In industrial practice, acetylene typically comprises between 0.5-3% of ethylene feedstocks. In order to avoid poisoning of the catalyst during ethylene polymerization, it is necessary to reduce acetylene concentrations to less than 5 ppm. Catalysts capable of improving this selectivity (i.e., for acetylene reduction) could significantly reduce the operational and energy costs associated with ethylene production. FIG. 12 depicts the sequential hydrogenation of acetylene (left) to ethylene (center) to ethane (right). Acetylene can also be reduced directly to ethane without passing through ethylene. It is an object of the present disclosure to maximize the concentration of ethylene and minimize the concentration of acetylene in some embodiments.

In one aspect, described herein are supported metal catalysts comprising an alkanethiol self-assembled monolayer. The alkane thiol can have any number of carbon atoms, although at least 18 carbon atoms are preferred. The catalysts are capable of selectively hydrogenating acetylene in a mixture of acetylene and ethylene. In some embodiments, the mixture of acetylene and ethylene comprises between about 0.5% and 3% acetylene. However, any initial concentration of acetylene is allowable in the mixture.

The concentration of acetylene in the mixture can be reduced to any suitable level. In some embodiments, the catalyst is capable of reducing the concentration of acetylene to about 10 ppm, about 5 ppm, about 3 ppm, about 2 ppm, about 1 ppm, about 0.5 ppm, about 0.1 ppm, and the like. In some embodiments, the catalyst is capable of reducing the concentration of acetylene to less than 10 ppm, less than 5 ppm, less than 3 ppm, less than 2 ppm, less than 1 ppm, less than 0.5 ppm, less than 0.1 ppm, and the like. In one aspect, the catalyst is capable of reducing the concentration of acetylene without substantially hydrogenating (e.g., less than 10%, less than 5%, less than 1%, or less than 0.1% of the ethylene is hydrogenated) the ethylene to ethane. In some embodiments, the selective hydrogenation of acetylene is achieved without addition of carbon monoxide to the mixture.

In one aspect, the selective hydrogenation is achieved without a substantial loss of activity when compared with the metal catalyst without an alkanethiol coating. In some embodiments, the activity of the supported metal catalyst comprising an alkanethiol self-assembled monolayer for acetylene hydrogenation is at least 70%, at least 80%, or at least 90% of the activity of the supported metal catalyst without the alkanethiol self-assembled monolayer.

### Methods for Making the Selective Catalyst

Also described herein are methods for making the selective catalyst. The method includes providing a supported metal catalyst. Supported metal catalysts include particles of transition metals, such as platinum, palladium, rhodium, ruthenium, osmium, iridium, nickel, copper, silver, or gold, embedded in a high surface material such as carbon, alumina, silica, zinc oxide, tungsten oxide, or titanium dioxide. Any combination of metal and high surface material (i.e., support) is suitable, including for example PdAl₂O₃. The metal atoms can be arranged in any suitable way and/or any suitable face of the metallic material may be used (including a mixture of different faces and/or metal atom arrangements). In one non-limiting embodiment, the surface of the metal is face-centered cubic, as represented by the notation (111).

In one aspect, the method for making the selective catalyst comprises coating the catalyst with a molecule, wherein the molecule comprises a hydrocarbon tail and at least one of a thiol, a selenide, a disulfide, and a diselenide. The hydrocarbon tails can have any suitable size, shape and chemical functionality. In some embodiments, the hydrocarbon tail comprises 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more carbon atoms. In some embodiments, the hydrocarbon tail comprises at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, or more carbon atoms.

In some embodiments, the hydrocarbon tails are sufficiently long and/or spaced sufficiently close to each other such that they form a self-assembled monolayer in which the tails are sterically and/or electrostatically prevented from laying down on the metal catalyst surface. In some embodiments, hydrocarbon tails comprising more than 12 carbon atoms are preferred.

The hydrocarbon tails include, but are not limited to alkanes of the formula CₙH₂ₙ₊₂, where n is an integer greater than or equal to one. Tail groups may also include alkenes, alkynes, alcohols, acids, amines, and aromatics, to name only a few examples. The hydrocarbon tails can have atoms other than hydrogen and carbon (e.g., nitrogen, oxygen). In some embodiments, the molecules coating the metal catalyst are amphiphilic (i.e., comprises hydrophobic portions and hydrophilic portions). The catalysts and use of catalysts described herein can have a single type of hydrocarbon tail, or may have a plurality of types of hydrocarbon tail. In some embodiments, the molecule is propanethiol (C3), hexanethiol (C6), dodecanethiol (C12), or octadecanethiol (C18).

Any method for coating the catalyst with the molecule is acceptable. In one embodiment, the catalyst is immersed in a solution comprising the molecule. The solution can have any suitable solvent including, but not limited to ethanol, water, acetone, hexane, heptane, and the like. The molecule can have any suitable concentration in the solution, optionally a low concentration. In some embodiments the molecule has a concentration of about 2 M, about 1 M, about 0.5 M, about 0.2 M, about 0.1 M, about 0.05 M, about 0.01 M, about 0.005M, about 0.001M, and the like. In some embodiments the molecule has a concentration of at most 2 M, at most 1 M, at most 0.5 M, at most 0.2 M, at most 0.1 M, at most 0.05 M, at most 0.01 M, at most 0.005M, at most 0.001M, and the like. In some embodiments the molecule has a concentration between about 0.01 M and 0.1 M, between about 0.005 M and 0.5 M, and the like. The catalyst can be immersed in the solution for any suitable amount of time, including between about 12 hours and 48 hours.

In one aspect, prior to coating the catalyst, the metal catalyst is optionally oxidized and then reduced. Oxidation and reduction of the catalyst can be performed in any suitable manner known to those skilled in the art. In one embodiment, the catalyst is oxidized in a 20% O₂ environment. The time, temperature, and any other conditions can be varied as needed to oxidize the catalyst. One embodiment is oxidation in a 20% O₂ environment for about 2 hours. Following oxidation, the catalyst is reduced in some embodiments. In one embodiment, the catalyst is reduced in a 20% H₂ environment. The time, temperature, and any other conditions can be varied as needed to reduce the catalyst. One embodiment is reduction in a 20% H₂ environment for about 4 hours.

In some embodiments, the catalyst is coated with thioglycerol. In some embodiments, the thioglycerol is in addition to the SAM coating (i.e., the coating molecule).

### Methods for Using the Selective Catalyst

The selective catalysts described herein are modified supported metal catalysts. For example, in some embodiments the alkanethiol coating modifies the specificity of the reaction, but does not otherwise change the way in which the catalyst is utilized. Therefore, the catalysts described herein can be used in any way that is already known for using supported metal catalysts. For example, the catalysts described herein can be packed into a reactor. Optionally, the catalysts described herein can substitute directly for a supported metal catalyst in an established process (e.g., reduction of acetylene in an ethylene production or polymerization process). In other embodiments, the catalysts described herein can be used in any combination with other designs, equipment, and the like to perform any suitable reaction (e.g., selective hydrogenation of a polyfunctional molecule derived from biomass).

In one aspect, a method is provided for selectively hydrogenating a polyfunctional feedstock. The method comprises providing a feedstock (wherein the feedstock comprises a plurality of chemical functionalities), providing a supported metal catalyst coated with a molecule (wherein the molecule comprises a hydrocarbon tail and at least one of a thiol, a selenide, a disulfide, and a diselenide), and contacting the feedstock with the catalyst at a temperature.

In one aspect, the feedstock comprises a plurality of functional groups. The functional groups may be found on molecule(s) comprising a plurality of functional groups (i.e., polyfunctional molecules) and/or may be found on separate molecules (e.g., a mixture of acetylene and ethylene). The feedstock therefore comprises at least two functional groups. In some embodiments, the feedstock comprises an olefin group, optionally with at least one epoxide, aldehyde, acid, nitrile, and/or alkyne. In some embodiments, the olefin group is selectively hydrogenated. The polyfunctional feedstock is derived from biomass in some embodiments. Exemplary molecules that may be used in the feedstock include 3,4-epoxy-1-butene (EpB), crotonaldehyde, itaconic acid, levulinic acid, 2,5-furandicarboxylic acid, and fumaric acid.

In one aspect, the method includes providing a supported metal catalyst coated with a molecule comprising a hydrocarbon tail and at least one of a thiol, a selenide, a disulfide, and a diselenide. Supported metal catalysts include particles of transition metals, such as platinum, palladium, rhodium, ruthenium, osmium, iridium, nickel, copper, silver, or gold, embedded in a high surface material such as carbon, alumina, silica, zinc oxide, tungsten oxide, or titanium dioxide. Any combination of metal and high surface material (i.e., support) is suitable, including for example PdAl₂O₃. The metal atoms can be arranged in any suitable way and/or any suitable face of the metallic material may be used (including a mixture of different faces and/or metal atom arrangements). In one non-limiting embodiment, the surface of the metal is face-centered cubic, as represented by the notation (111).

The molecule coating the supported metal catalyst comprises a hydrocarbon tail and at least one of a thiol, a selenide, a disulfide, and a diselenide. The hydrocarbon tails can have any suitable size, shape and chemical functionality. In some embodiments, the hydrocarbon tail comprises 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more carbon atoms. In some embodiments, the hydrocarbon tail comprises at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, or more carbon atoms.

In some embodiments, the hydrocarbon tails are sufficiently long and/or spaced sufficiently close to each other such that they form a self-assembled monolayer in which the tails are sterically and/or electrostatically prevented from laying down on the metal catalyst surface. In some embodiments, hydrocarbon tails comprising more than 12 carbon atoms are preferred.

The hydrocarbon tails include, but are not limited to alkanes of the formula CₙH₂ₙ₊₂, where n is an integer greater than or equal to one. Tail groups may also include alkenes, alkynes, alcohols, acids, amines, and aromatics, to name only a few examples. The hydrocarbon tails can have atoms other than hydrogen and carbon (e.g., nitrogen, oxygen). In some embodiments, the molecules coating the metal catalyst are amphiphilic (i.e., comprises hydrophobic portions and hydrophilic portions). The catalysts and use of catalysts described herein can have a single type of hydrocarbon tail, or may have a plurality of types of hydrocarbon tail. In some embodiments, the molecule is propanethiol (C3), hexanethiol (C6), dodecanethiol (C12), or octadecanethiol (C18).

In some embodiments, the method further comprises coating the catalyst with thioglycerol. In some embodiments, the method comprises providing a supported metal catalyst coated with thioglycerol. Without limitation, catalysts coated with thioglycerol (e.g., in addition to the SAM coating) can exhibit enhanced selectivity for certain reactions (e.g., conversion of EpB to epoxybutane) in the liquid phase (e.g., where heptane is the solvent).

In various embodiments, the feedstock can be a gas, liquid, supercritical fluid, or any combination thereof. Without limitation, the feedstock may further comprise thioglycerol (e.g., in addition to a polyfunctional molecule) in order to enhance selectivity for certain reactions (e.g., conversion of EpB to epoxybutane) in the liquid phase (e.g., where heptane is the solvent). In some embodiments, the selectivity for epoxybutane production from an EpB feedstock is at least 50% when the solvent is a mixture of heptane and thioglycerol.

In one aspect, the method for using the catalyst described herein comprises contacting the feedstock with the catalyst at a temperature. The temperature may be such that at least one chemical functionality of the feedstock is hydrogenated and the coating is not substantially desorbed or degraded. The coating is not substantially desorbed or degraded if the catalyst can be used under the reaction conditions (e.g., temperature) a plurality of times (e.g., at least 10, 50, 100, or 1,000 times) and/or for an extended period of time (e.g., 1 day, 1 week, 1 month, 1 year, or 5 years) without a significant loss of specificity and/or activity (e.g., a loss of at most 10%, 5%, 2%, or 1%). In some embodiments, the temperature is about 275 K, about 300 K, about 325 K, about 350 K, about 400 K, about 600 K, and the like. In some embodiments, the temperature is at most 275 K, at most 300 K, at most 325 K, at most 350 K, at most 400 K, at most 600 K, and the like. In some embodiments, the temperature is at least 275 K, at least 300 K, at least 325 K, at least 350 K, at least 400 K, at least 600 K, and the like. In some embodiments, the temperature is between about 313 K and 333 K, between about 300 K and 350 K, and the like.

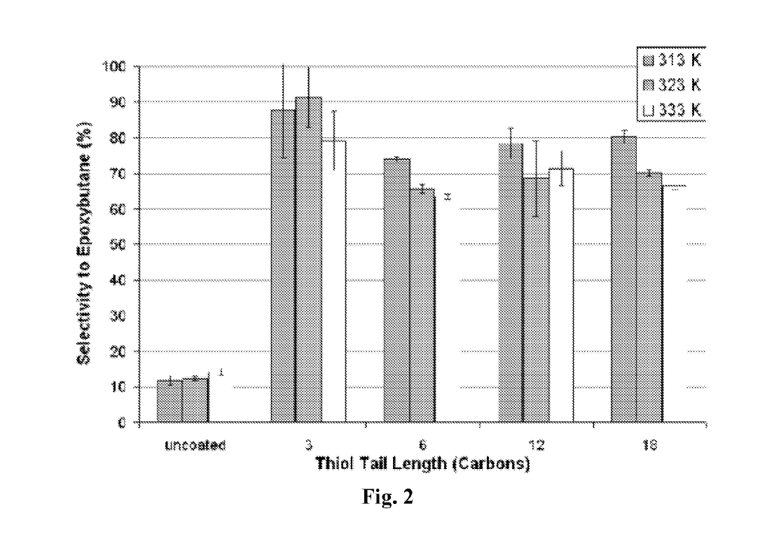

FIG. 2 shows the selectivity to Epoxybutane versus Tail Length for various exemplary alkanethiol coatings in an exemplary embodiment. For each tail length, the selectivity is presented at 313 K (left most bar of each 3-bar set), at 323 K (middle), and at 333 K (right).

In one aspect, the methods described herein for selectively hydrogenating the feedstock achieve high selectivity without a substantial loss in activity (i.e., rate). In some embodiments, the turnover frequency (i.e., rate) of hydrogenation with the catalyst comprising the molecular coating is about 10%, about 20%, about 30%, about 40%, about 50%, about 60%, about 70%, about 80%, about 90%, and the like of the rate of hydrogenation with the catalyst without the molecular coating. In some embodiments, the turnover frequency (i.e., rate) of hydrogenation with the catalyst comprising the molecular coating is at least 10%, at least 20%, at least 30%, at least 40%, at least 50%, at least 60%, at least 70%, at least 80%, at least 90%, and the like of the rate of hydrogenation with the catalyst without the molecular coating.

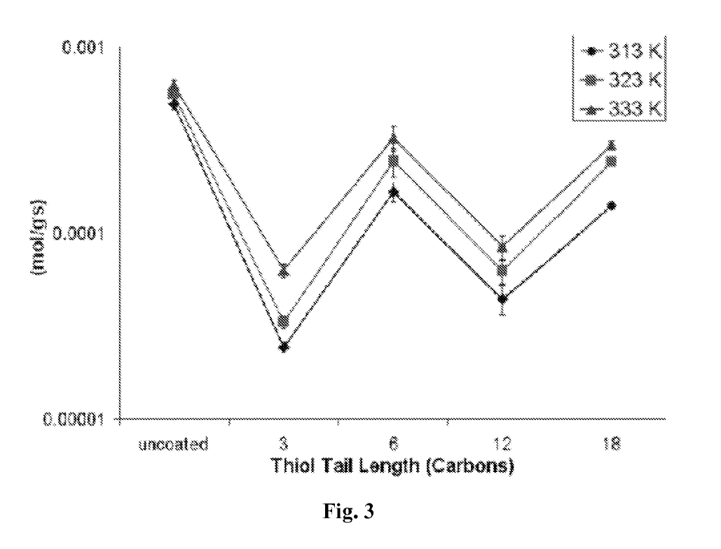

FIG. 3 is a plot of Rate versus Tail Length for an exemplary alkanethiol coated 5% Pd/Al₂O₃. For each tail length, the rate is presented at 313 K (circles; bottom most line), at 323 K (squares; middle), and at 333 K (triangles; top).

### Exemplary Uses of the Selective Catalyst

The hydrogenation of unsaturated epoxides is one class of reactions that can be performed using the highly selective catalyst described herein. These molecules form one component of a growing feedstock of unsaturated oxygenates derived from biomass. In addition, a process exists to produce a model unsaturated epoxide (3,4 epoxy 1-butene (EpB)), from butadiene on supported silver catalysts. EpB contains two functional groups: a C—O—C epoxide ring, and a C═C double bond. Selective hydrogenation of the double bond produces epoxybutane, a valuable commodity chemical used in the manufacture of polyethers, surfactants, glycols, polyesters, epoxy resins, and fuel additives (see FIG. 8). However, hydrogenation of EpB's double bond is difficult. EpB forms many products with hydrogen. Epoxides primarily undergo ring opening on platinum group metals to form aldehydes, ketones, and alcohols. For example, reaction of EpB with hydrogen on supported palladium and platinum yield selectivities for epoxybutane of less than 20%. Provided herein is a method comprising contacting 3,4-epoxy-1-butene (EpB) with the catalysts described herein wherein at least 30% of the 3,4-epoxy-1-butene (EpB) is converted to epoxybutane (see FIG. 9). In some embodiments, at least 40%, at least 50%, at least 60%, at least 70%, or at least 80% of the 3,4-epoxy-1-butene (EpB) is converted to epoxybutane. The method further comprises converting the epoxybutane to at least one of a polyether, surfactant, glycol, polyester, epoxy resin, and fuel additive. The epoxybutane, polyether, surfactant, glycol, polyester, epoxy resin, and fuel additive produced by the methods described herein is also within the scope of the present invention.

A process is known which achieves 84-90% selectivity for epoxybutane by using a combination of rhodium catalysts and hydrogen pressures up to 5.6 MPa. But this is far from the mild conditions generally preferred for olefin hydrogenation reactions. In one embodiment, the catalysts described herein do not comprise rhodium. In one aspect, methods are described herein that use hydrogen pressures less than 5.6 MPa. In some embodiments, the hydrogen pressure is at most 5 MPa, at most 3 MPa, at most 1 MPa, at most 0.5 MPa, at most 0.1 MPa, and the like. A process is also known which achieves 55% selectivity for epoxybutane using a platinum-silver bimetallic catalyst. In one embodiment, the catalysts described herein do not comprise platinum and/or silver. Another process utilizes a binuclear palladium homogeneous catalyst with (t-butyl)₂ phosphide ligands. In one embodiment, the catalysts described herein are heterogeneous. In one embodiment, the catalysts described herein do not comprise (t-butyl)₂ phosphide ligands. In one aspect, the catalysts described herein and methods for making and using the catalysts described herein comprise catalysts with a SAM coating of an alkanethiol.

In one embodiment, the polyfunctional feedstock comprises crotonaldehyde, and contacting the feedstock with the catalyst results in butyraldehyde at a yield of at least 80% and a conversion of at least 50%. The butyraldehyde produced by the methods described herein is also encompassed within the scope of the present invention.

In one embodiment, the polyfunctional feedstock comprises a mixture of acetylene and ethylene, and contacting the feedstock with the catalyst results in selective reduction of the acetylene. In some embodiments, contacting polyfunctional feedstock with the catalyst produces an ethylene product, wherein the ethylene product has a concentration of acetylene below 5 ppm. In some embodiments, the catalyst reduces acetylene at a rate that is at least 1,000 times faster than the rate of ethylene reduction. The ethylene product (or products produced by the polymerization thereof) produced by the methods described herein is also encompassed within the scope of the present invention.

### CERTAIN DEFINITIONS

The articles “a”, “an” and “the” are non-limiting. For example, “the method” includes the broadest definition of the meaning of the phrase, which can be more than one method.

The term “about” means that the parameter may vary by at most 60%, at most 50%, at most 20%, at most 10%, or at most 5%, in various embodiments.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### EXAMPLES

### Example 1

### Preparation of Alkanethiol Coated Catalysts

Prior to thiol deposition, catalysts were treated by oxidation in a 20% O₂ environment for about 2 hours, followed by a reduction in a 20% H₂ environment for more than about 4 hours. Catalysts were then coated via immersion in a 0.1 M solution of propanethiol, hexanethiol, or dodecanethiol in ethanol for about 48 hours. Octadecanethiol coatings were formed by immersion in a 0.05 M concentration solution due to the lower solubility of longer thiols in ethanol. This deposition procedure is similar to those employed on polycrystalline metal surfaces; however, the thiol concentration used for coating the catalysts is higher. Catalysts were tested at 313, 323, and 333 K. These temperatures are in the range commonly used for hydrogenation reactions, yet low enough to prevent desorption or rearrangement of the thiol coating. It is noted that coated catalysts behave similarly under a variety of deposition conditions including thiol concentrations ranging from 0.01 M to 0.1 M and immersion times ranging from 12 hours to 48 hours.

Pd/Al₂O₃ (5 wt %), 1-propanethiol, 1-hexanethiol, 1-dodecanethiol, 1-octadecanethiol, 1-dodecene, 1-hexene, crotonaldehyde (2-buten-1-al, 97%) and 200-proof HPLC-grade ethanol were obtained from Sigma Aldrich. All thiol and alkene purities were greater than 97%. EpB (>98%) was obtained from Alfa Aesar and all gases were ultrahigh purity and were obtained from Airgas.

Before thiol deposition and/or testing, 7.0 mg (uncoated case) or 50.0 mg (coated cases) of 5% Pd/Al₂O₃ catalyst diluted to 300 mg with Pd/Al₂O₃ was packed into a glass reactor tube and cleaned by oxidation at 573 K in 20% oxygen for two hours. The catalyst was then reduced at 473 K in 20% hydrogen for greater than 2 h and cooled to room temperature in an inert flow of He. Thiol coatings were deposited by immersing the packed catalyst bed at room temperature in 10 mM ethanolic solutions of propanethiol, hexanethiol or dodecanethiol or 1 mM ethanolic solutions of octadecanethiol for 24 h, except where specified otherwise. The coated catalyst was dried in an inert flow of nitrogen or helium for at least 12 h before being tested. Sulphur-coated catalysts were prepared by exposing 50.0 mg of 5% Pd/Al₂O₃ catalyst packed in a glass reactor tube to 1,000 ppm H₂S in N₂ at a flow rate of 200 s.c.c.m. for varying amounts of time and then purging with N₂. The catalysts aged in alkenes were prepared by exposing 50.0 mg of 5% Pd/Al₂O₃ catalyst to a flow of helium with 1% propylene or 1-hexene or 0.1% 1-dodecene for 4 h at 373 K.

Coated and uncoated catalysts were characterized using DRIFT spectroscopy to collect spectra in the C—H stretching region (2,800 cm⁻¹ to 3,000 cm⁻¹) using a Thermo Nicolet 6,700 FTIR. DRIFT spectra were corrected by subtracting a background spectrum of oxidized and reduced 5% Pd/Al₂O₃ catalyst and adjusting for baseline drift. A resolution of 4 cm⁻¹ was used.

CO chemisorption (Quantachrome Autosorb-1) was also used to characterize the surface area of exposed Pd on the coated and uncoated catalyst. We measured a metal surface area of 3.74 m² on the uncoated catalyst that dropped to 0.23 m² g⁻¹ after coating with hexanethiol using CO chemisorption, indicating that 94% of the metal surface was modified by the adsorbed thiol. The palladium metal dispersion was 16.8% and the average metal particle diameter (assuming a spherical shape) was 6.7 nm.

### Example 2

### Tests of Catalytic Activity

In the Examples described herein, tests of alkanethiol coated catalysts show high selectivity and good activity for hydrogenation of C—C double bonds over oxygenate functional groups. These tests of catalytic activity were conducted using a packed bed reactor containing 10.0 mg of coated or 1.0 mg of uncoated catalyst (5% Pd/Al₂O₃, Sigma Aldrich) diluted to 300 mg with alumina (Sigma Aldrich). EpB (98%, Alfa Aesar) was exposed to the catalyst via saturating a 12.7 sccm flow of UHP helium (Airgas) at 298K. UHP hydrogen (Airgas) was also flown over the catalyst at a rate of 12.7 sccm. Inlet and effluent gas concentrations were measured with a gas chromatograph (GC, HP5890) equipped with a capillary column and a flame ionization detector. This system enabled sufficient separation of all reaction products to quantify concentration.

Reaction products were quantified using a gas chromatograph (HP5890) equipped with a flame ionization detector, a Poraplot-Q capillary column (Varian) and peak simple software (SRI). The packed catalysts were exposed to a feed stream with a 10:1 H₂ to EpB ratio, produced by entraining EpB in a He flow at 298 K with a bubbler. A constant feed flow rate of 25 s.c.c.m. for thiol- and sulphur-coated catalysts was chosen to produce 5±2% conversion of EpB unless otherwise noted. Reactions were conducted at 313, 323 and 333 K by heating the glass reactor tubes in a temperature-controlled clamshell-style furnace. Selectivities were calculated by dividing the conversion to one product by the total EpB conversion. Turnover frequencies were calculated on the basis of the metal surface area of the uncoated catalyst. This method does not account for reductions in the number of active sites resulting from the thiol coating or carbonaceous deposits and may underestimate the true turnover frequency. Experiments testing crotonaldehyde hydrogenation were conducted similarly using a 25:1 H₂ to crotonaldehyde feed ratio and 1 g of uncoated or hexanethiol-coated 5% Pd/Al₂O₃ catalyst at 313 K.

### Example 3

### Reaction with EpB

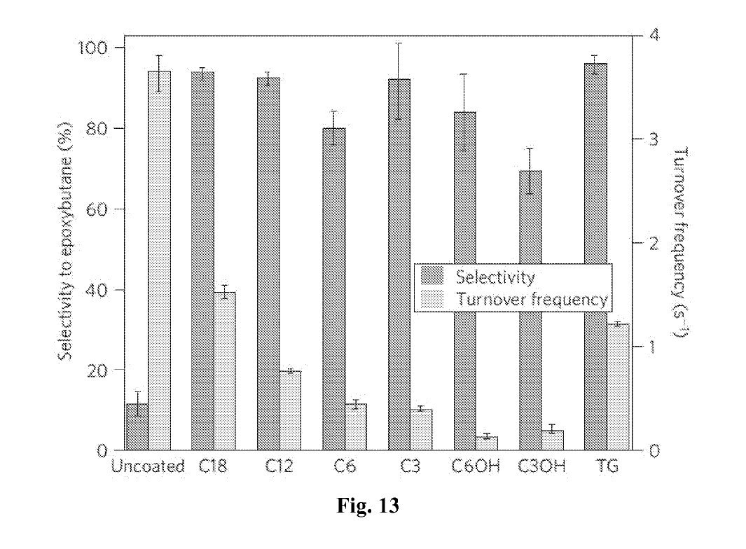

GC analysis reveals the primary products produced by reaction of EpB and hydrogen on the thiol-modified Pd catalysts include epoxybutane and crotonaldehyde with several minor products including butyraldehyde, crotyl alcohol, and butanol. On un-modified palladium catalysts, selectivity for conversion of EpB to epoxybutane is less than about 15% (see FIG. 13, left axis). On thiol-modified palladium catalysts, selectivities for conversion to epoxybutane over 70% are achieved, as shown by the plot in FIG. 13. While it may be expected that hydrogenation rates would drop severely upon catalyst coating (e.g., by metal site blocking or sulfur poisoning); this was not observed. While the overall rate of epoxybutene consumption does drop significantly (see FIG. 13, right axis), the rate of epoxybutane formation drops less than an order of magnitude for the octadecane thiol. For propanethiol, hexanethiol and dodecanethiol coated catalysts, a significant drop in hydrogenation rate was observed.

FIG. 13 summarizes the effectiveness of alkanethiol SAMs on conventional Pd/Al₂O₃ catalysts in enhancing selective EpB reduction to epoxybutane. Alkanethiol coatings with varying tail lengths were evaluated and characterized including propanethiol (C3), hexanethiol (C6), dodecanethiol (C12) and octadecanethiol (C18). On uncoated palladium catalysts, selectivity for epoxybutane at 313 K was 11% at 5% EpB conversion. After applying the alkanethiol coatings, the selectivity for epoxybutane increased to 80-94% at the same conversion depending on thiol tail length, as shown in FIG. 13. On the coated catalysts, crotonaldehyde was the main by-product (3-15%), with butyraldehyde and alcohols as minor products (<2% each). The uncoated catalyst primarily produced crotonaldehyde (36%), alcohols (44%) and butyraldehyde (7%) along with small amounts of deoxygenation and decarbonylation products in addition to epoxybutane.

Experiments were also conducted varying the amount of catalyst (up to 200 mg) and the total feed flow rate to evaluate selectivity as a function of EpB conversion for the uncoated and octadecanethiol-coated catalysts at 313K. Whereas selectivity on the uncoated catalyst exhibited a maximum of 31±3% at less than 1% EpB conversion and decreased to 8±2% at between 99 and 100% EpB conversion, selectivity on the C18-coated catalyst was greater than 99% at less than 1% conversion, and 53±2% at between 99 and 100% conversion.

As shown in FIG. 13, the activity of the SAM-coated catalysts (shown as apparent turnover frequency) decreased relative to the uncoated catalyst, and increased significantly with increasing thiol tail length despite the increasing thickness of the monolayer film above the active surface. The most active SAM-coated catalyst, C18, exhibited epoxybutane formation rates that were approximately 40% of the rate for the uncoated catalyst. Each experiment was conducted over a period of up to 12 h, during which no deactivation was observed. Experiments conducted at 323 and 333 K showed similar trends as the results in FIG. 13.

Taken together, the data in FIG. 13 show that although the identity of the moiety attached to the thiol group (that is, the so-called tail group) is a major determinant of the activity of the modified catalyst, the selectivity is essentially independent of the tail group identity, and is therefore likely to be due to the arrangement of the sulphur atoms. This conjecture is supported by further experiments we carried out in which the catalyst was coated with SAMs comprising hydroxy-terminated C3 and C6 alkanethiols and thioglycerol. Although the activity associated with monolayers produced from the hydroxylated thiolates varied significantly, as shown in FIG. 13, the selectivity was again high across all SAMs.

### Example 4

### Activation Energies

Quantifying reaction rates as a function of temperature enables the determination of apparent activation energy through an Arrhenius plot. Apparent activation energies for olefin hydrogenation reactions overwhelmingly lie between 29 and 42 kJ/mol, regardless of rate.

Values of apparent activation energy falling outside this range indicate a change in the reaction mechanism. Experimental values for activation energy ranged between 28.5±4.1 kJ/mol for hexanethiol coated catalysts and 41.4±3.3 kJ/mol for propanethiol coated catalysts, so thiol coated catalysts appear to behave similarly to their metal counterparts and likely share a similar hydrogenation mechanism.

Quantifying reaction rates at different temperatures enables the determination of apparent activation energies. Apparent activation energies for olefin hydrogenation reactions are generally found to be 33-42 kJ mol⁻¹ on a variety of metals with different electronic and geometric structures. Values outside this range indicate a change in the reaction mechanism for hydrogenation or a change in the rate-determining step, such as the desorption of tightly bound carbon monoxide (CO) to make space for the reactants or mass-transfer limitations. Experimental values for activation energy were 41±3, 42±3, 41±4 and 39±2 kJ mol⁻¹ for the C3-, C6-, C12- and C18-coated catalysts respectively. These values indicate that thiol-coated catalysts seem to behave similarly to their traditional metal counterparts and probably share a similar olefin hydrogenation mechanism. In addition, these results suggest that the presence of the SAM does not induce a significant mass-transfer barrier for the diffusion of EpB through the SAM coating to the metal surface.

### Example 5

### DRIFTS Spectroscopy

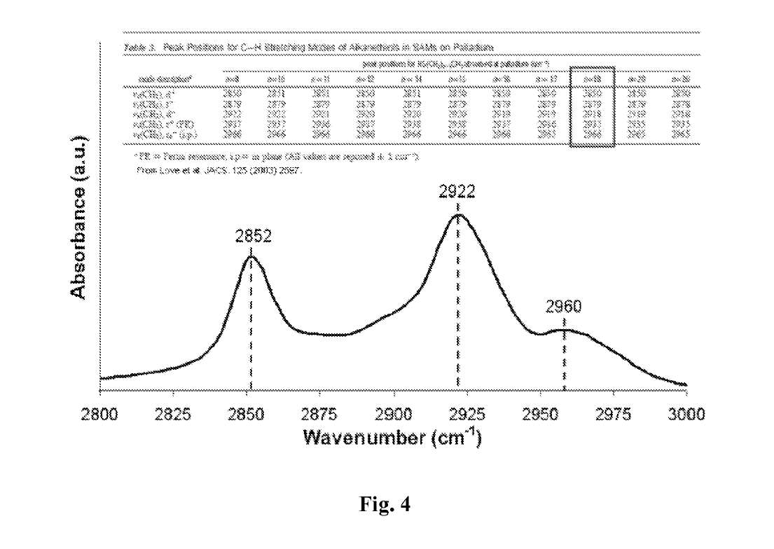

Diffuse reflectance infrared Fourier transform spectroscopy (DRIFTS) can be utilized for monitoring the formation of alkanethiol SAMs on flat metal surfaces. See, e.g., FIG. 4. A DRIFTS spectrum was obtained for a 5% Pd/Al₂O₃ catalyst coated with octadecanethiol by suspension in a 0.05 M solution for about 48 hours. Freshly oxidized and reduced palladium catalyst was used to establish a background. This spectrum shows the octadecanethiol has adsorbed in a SAM “like” structure. That is, the spectrum suggests that the alkyl chains of the adsorbed octadecanethiol molecules adopt a structure with little orientational or conformational flexibility and few gauche defects, similar to what is generally observed in well-organized SAMs. In addition, the relative intensity of methylene modes with respect to methyl modes, which appear as shoulders to methylene modes, suggests the thiol tails form a large angle with the surface normal. This angle predicted by this analysis is much larger than those observed on polycrystalline samples.

### Example 6

### DRIFTS Spectroscopy

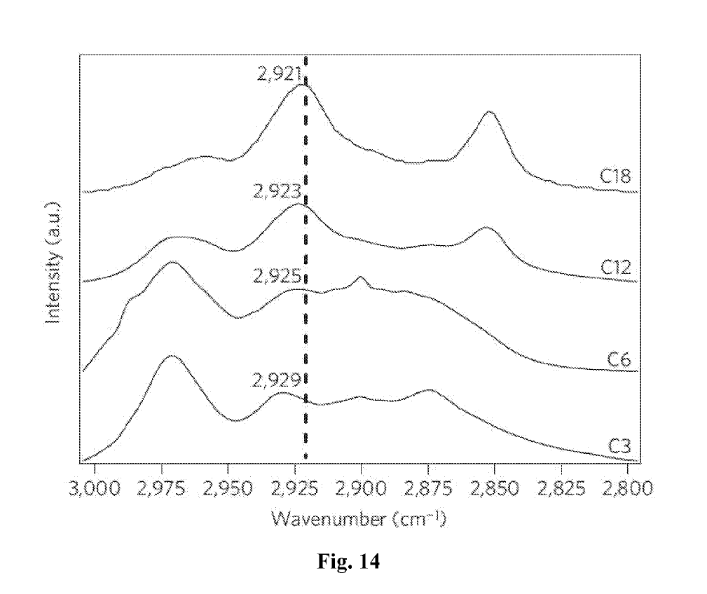

Vibrational spectroscopy has been used extensively to determine the degree of molecular organization with SAMs deposited on Pd, Ag, Cu and Au. In particular, SAMs exhibit a greater number of Gauche defects with increasing disorder, causing the methylene d⁻ stretching mode to shift from ˜2,920 cm⁻¹, a value consistent with crystalline alkanes, to 2,928 cm⁻¹, a value consistent with liquid- or solution-phase alkanes. Diffuse reflectance infrared Fourier transform (DRIFT) spectra of the alkanethiol-coated catalysts deposited from 10 mM ethanolic solutions are shown in FIG. 14. For the C3-coated catalyst, the methylene d⁻ stretching mode was observed at 2,929 cm⁻¹, indicating that the thiol tails were highly disordered and in a liquid-like state. On the C6- and C12-coated catalysts this mode was observed at 2,925 and 2,923 cm⁻¹, respectively, indicating more-ordered monolayers. The C18-coated catalyst exhibited this mode at 2,921 cm⁻¹, consistent with an ordered SAM on polycrystalline palladium. The correlation between alkyl chain order and catalytic activity is striking, and suggests that within the homologous series of alkanethiols, coatings with greater molecular order have higher activity compared with less well-ordered coatings.

### Example 7

### CO Chemisorptions Measurements

Thiol coated catalysts were also characterized using carbon monoxide chemisorption experiments. In this technique a known catalyst mass is exposed to a carbon monoxide pulse. Measuring the carbon monoxide remaining after exposure to the catalyst as a function of the pulse size yields an isotherm that can be used to determine the active metal surface area. Temperature programmed desorption (TPD) experiments, using the technique described below, revealed carbon monoxide may not stick on a thiol coated surface above 300 K. Thus, comparing chemisorption data before and after applying a thiol coating provides the fraction of surface sites modified by the thiol. This experiment was performed at 323 K using a chemisorption system for 5% Pd/Al₂O₃ catalyst before and after applying a hexanethiol coating using the same procedures described above. Before thiol coating, the palladium catalyst had a metal surface area of 3.74 m²/g. After coating the measured area dropped to 0.23 m²/g, indicating 94% of the palladium metal surface is modified by thiols. This technique provides a clearer picture of the catalyst surface when used with the DRIFTS experiments described above.

Supported metal catalysts are naturally quite complicated. For this reason, model systems may be employed to gain a fundamental understanding of the adsorption processes. To maintain a clean surface and isolate surface species, these experiments were conducted under ultra-high vacuum conditions (<10⁻⁸ torr) and at cryogenic temperatures. Metal surfaces were employed that simplify the complex structural properties of supported metal particles. The palladium (111) crystal plane was used because it is the most common plane.

### Example 8

### CO Chemisorptions Measurements

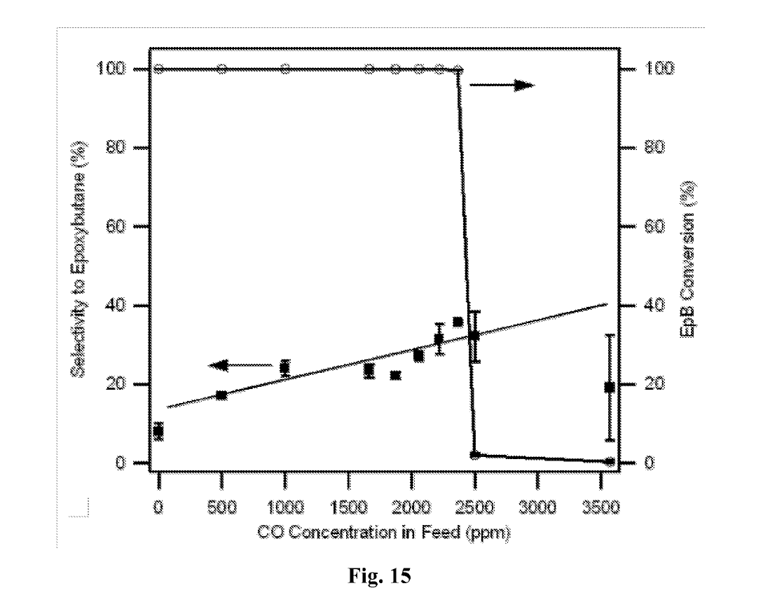

The contrast between the uniformly high epoxybutane selectivity for all of the alkanethiol coatings and the activity varying with tail length suggests differing mechanisms for the effect of the SAMs on selectivity and activity. One possible mechanism by which SAMs may enhance selectivity is through site blocking to control ensemble sizes. Surface modification to control metal ensemble size is a common and effective practice to improve selectivity in a variety of systems, such as the synthesis of vinyl acetate on Pd—Au bimetallic catalysts. To determine whether ensemble effects alone may be responsible for the enhanced selectivity of thiol-coated catalysts, EpB hydrogenation experiments were conducted using a feed containing a variable amount of CO. Unlike sulphur, CO primarily blocks olefin hydrogenation sites without significantly impacting electronic structure. Therefore, varying CO exposure probes the impact of ensemble sizes and adsorbate mobility. In addition, at coverages up to ⅓ of a monolayer, CO adsorbs in a (√3×√3)R30 structure on Pd(111) hollow sites, which is the same structure observed for hexanethiol SAMs on Au(111). Selectivity and activity for epoxybutane were evaluated for CO concentrations up to 3,500 ppm, at which point the catalyst activity became negligible. A modest, approximately linear, increase in selectivity to epoxybutane with CO concentration was observed, with a maximum selectivity of only ˜30% when the surface was nearly saturated with CO. As the catalyst approached saturation, the reaction rate dropped suddenly at 2,500 ppm CO. This step change is similar to the step change observed in the activation barrier of ethylene hydrogenation in the presence of increasing concentrations of CO on Pt(111). A plot of these data is shown in FIG. 15. As the observed maximum in selectivity closely matches the selectivity of the palladium catalyst at low conversion (31±3%), it is clear that ensemble effects alone do not play a critical role in the observed selectivity enhancement.

### Example 9

### Temperature Programmed Desorption (TPD) Spectroscopy

In TPD, a surface is cooled to cryogenic temperatures and dosed with a known adsorbate quantity. The surface is then heated at a constant rate and desorbing products are measured using mass spectrometry. The identity of desorbing products, their desorption temperature, and the amount of material that desorbed can be determined and used to identify reaction pathways.

Temperature Programmed Desorption (TPD) experiments were conducted in an ultra high vacuum chamber with a base pressure of ˜10⁻¹⁰ torr (10⁻⁸ Pa). The system was equipped with a Smart-IQ+ quadrupole mass spectrometer (VG Scienta) and a model NGI3000-SE sputter gun for cleaning (LK Technologies). EpB and epoxybutane were dosed in equivalent quantities to the hexanethiol SAM coated Pd(111) sample at 100 K using a direct dosing line facing the sample. Similar doses produced coverages on clean Pd(111) of approximately 0.1 monolayers in previously. Cooling below ambient temperature was accomplished through a liquid nitrogen reservoir located in thermal contact with the sample. Experiments were conducted by heating the sample at a constant rate of 1 K/s until the sample reached 323 K.

The Pd(111) crystal (Princeton Scientific) was cleaned primarily through cycles of cooling and heating in 5×10⁻⁸ torr O₂ (7×10⁻⁶ Pa) between 400K and 1000K prior to hexanethiol SAM deposition. When this cleaning method was insufficient, mild sputtering with Ar⁺ ions (1-3 keV) and annealing was utilized. Temperature was measured using a thermocouple welded next to the crystal on a copper sample stage. The hexanethiol SAM was deposited by removing the clean Pd(111) crystal from vacuum and placing it in a 10 mM solution of hexanethiol in ethanol for 12 hours. The crystal was then removed from the solution and rinsed with ethanol. Before being reinserted into the vacuum chamber, the quality of the coating was evaluated by measure the advancing contact angle of water using goniometry. In some embodiments, surface hydrophobicity correlates well with SAM quality. For the hexanethiol SAM coated Pd(111) surface used in these studies, an advancing contact angle of 120° was acquired, indicating a high-quality SAM similar to those observed on polycrystalline palladium.

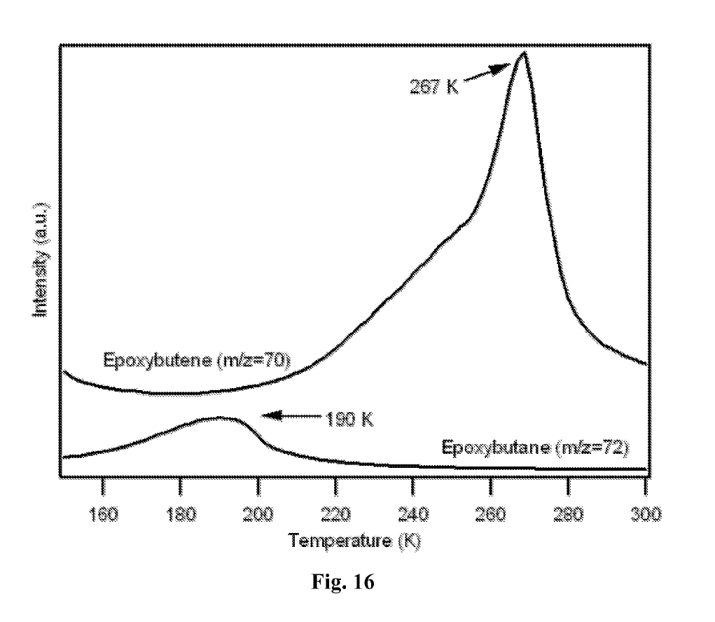

Initial surface science work identified relative binding energies of EpB and a similar molecule, crotonaldehyde (CrHO), on the Pd(111) surface. TPD experiments were run with EpB adsorbed onto clean Pd(111) at various exposures. The dominant products observed were hydrogen, carbon monoxide, and propylene, which indicate a decarbonylation pathway. Sample TPD spectra for EpB are shown in FIG. 16. Here, EpB and epoxybutane were dosed to the sample at 150 K. Previous experiments observed ring opening of EpB at temperatures below 190 K. In the experiments shown here, no ring-opened products were observed. Similar results were observed for CrHO.

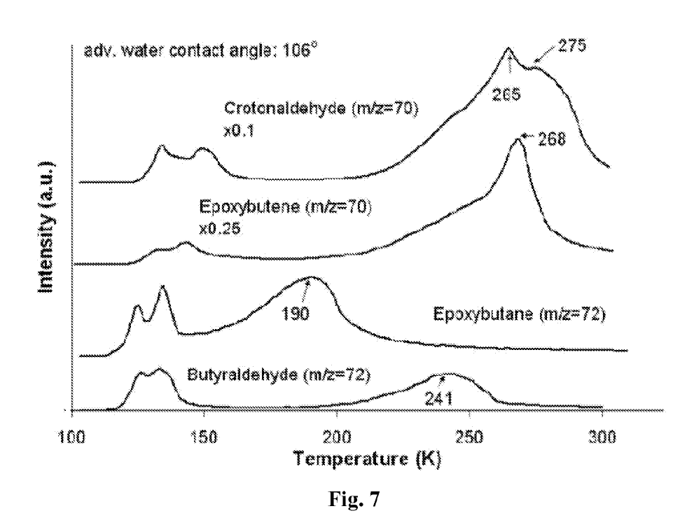

To study the effect of SAMs on the EpB adsorption, the Pd(111) crystal was cleaned and removed from the vacuum. A hexanethiol SAM was deposited by immersing the crystal in a 10 mM hexanethiol solution in ethanol for more than 8 hours. The SAM quality was evaluated by acquiring the advancing water contact angle on the coated surface with goniometry and the coated Pd(111) crystal was reinserted into the vacuum chamber. TPD of the thiol coated Pd(111) showed fragmentation and desorption of the thiol SAM by 150° C. and previous work shows SAMs restructure above 50° C., so all TPD experiments below were run to a 50° C. maximum. These initial TPD experiments were conducted by adsorbing moderate oxygenate doses at −173° C. To establish trends in binding multiple oxygenates were tested, including epoxybutene, epoxybutane, crotonaldehyde, and butyraldehyde. Four resulting spectra from separate experiments are shown in FIG. 7.

Unlike TPD spectra observed on clean Pd(111), these spectra show intact desorption only. Since EpB decomposition on clean Pd(111) proceeds through decarbonylation of the oxygenate functionality, the epoxide does not interact strongly with the surface on SAM coated Pd(111). This conclusion is further supported by the similarity between CrHO and EpB spectra. In addition, the saturated analogs of these molecules bind weakly, indicating the higher EpB and CrHO desorption temperatures are likely due to interaction of the olefin with the surface.

### Example 10

### HREELS Spectroscopy

HREELS is an electron analog of infrared spectroscopy. HREELS may only operate under ultrahigh vacuum conditions, but achieves higher resolution in the low wavenumber range (<1500 cm⁻¹) and is capable of circumventing common selection rules through measurement in an off specular direction.

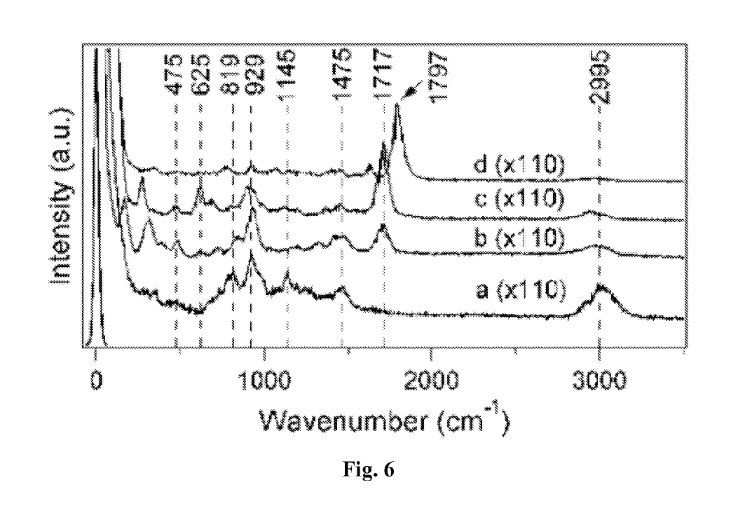

HREELS experiments were conducted by dosing EpB at 140K and then subsequently annealing for two minutes at 190, 250, and 350K. The sample was allowed to cool and spectra were taken at a specular angle in between annealing steps to track the thermal evolution of the adsorbate. Results for this experiment are shown in FIG. 6.

The spectra show key details of EpB evolution on this surface. In the HREEL spectra, a carbon-carbon double bond stretch (normally at 1650 cm⁻¹) is absent. This result indicates that the carbon-carbon double bond is horizontal with the surface, likely interacting in a pi or di-sigma bound state. Second, at low temperatures a C—O—C deformation mode appears at 819 cm⁻¹, indicating the epoxide ring is intact. As the EpB covered surface is heated, this mode disappears and a carbonyl mode appears at 1717 cm⁻¹. As the sample is further heated, this mode shifts to a higher wavenumber, indicating decarbonylation. Overall, the TPD and HREELS experiments show EpB first adsorbs to the surface through its olefin functionality. As the surface is heated, the more sterically hindered carbon-oxygen bond in the epoxide ring is broken to form an aldehyde-like intermediate. This intermediate decarbonylates to form propylene, carbon monoxide, and hydrogen.

### Example 11

### Selective Reduction of Acetylene

Ethane production from acetylene is typically described by both parallel and consecutive pathways. A simplified reaction scheme is shown in FIG. 12. One route involves the direct hydrogenation of acetylene to ethane while the consecutive route accounts for the formation of gas phase ethylene as an intermediate. To independently investigate the second reaction step of the consecutive pathway, ethylene hydrogenation rates were measured and compared between coated and uncoated surfaces. Before reaction, all catalysts were oxidized at 573 K in 20% O₂ for three hours then reduced at 473 K in 20% H₂ for at least two hours. Samples to be coated were then immersed in 1 mM ethanolic solution of octadecanethiol (C18) for at least 12 h and dried in an inert flow of helium for at least 12 h. Ethylene hydrogenation was conducted using a 5:1 H₂ to ethylene ratio at 306 K. As shown in Table 1, the presence of the C18 SAM coating was found to dramatically slow ethylene hydrogenation to ethane by a factor of ˜3,000 (i.e., the numbers in Table 1 are fractions of the rate on coated divided by uncoated surfaces).

TABLE 1
Hydrogenation reaction rates for C18 coated surfaces relative to
uncoated surfaces.

| | C18 Coated |
|---|---|
| Ethylene | (3.2 ± 0.3) × 10⁻⁴ |
| Acetylene | 1.1 ± 0.4 |
| EpB | (5.1 ± 0.2) × 10⁻² |

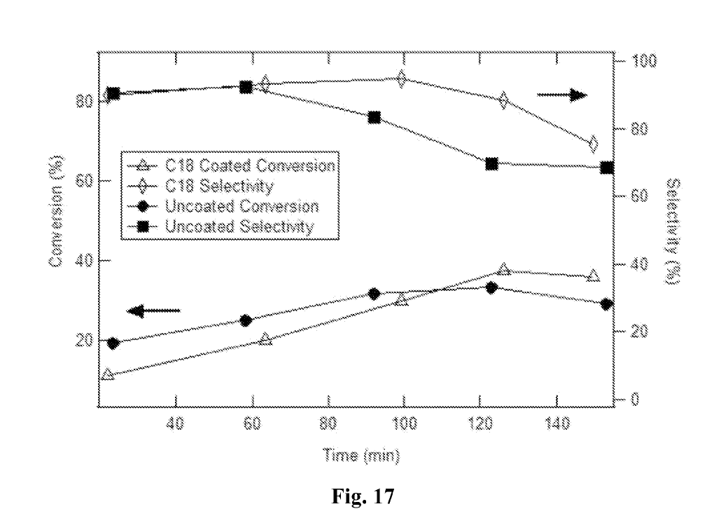

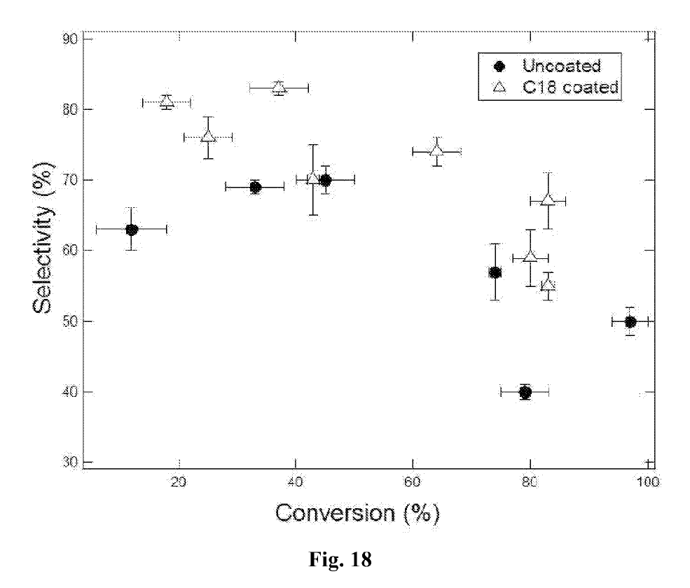

Acetylene hydrogenation experiments were then conducted using a 5:1 H₂ to acetylene ratio at 306 K. In the early stages of each reaction, the catalytic activity for both coated and uncoated surfaces was found to increase until a maximum conversion was reached. At this point, activity and selectivity were found to slowly decrease over time for both coated and uncoated catalysts (FIG. 17). This deactivation process is common for supported Pd catalysts during acetylene hydrogenation and, without being held to any particular theory is apparently caused by the build-up of polymeric carbonaceous species known as “green oil”. Selectivity to ethylene as a function of acetylene conversion at the maximum conversion for a series of experiments with different catalyst loadings is shown in FIG. 18. Since activity was found to vary with time, fresh samples were prepared and used for each measurement to make direct comparisons at the point of highest conversion. As discussed further below, the selectivity was systematically higher for C18-coated catalysts.

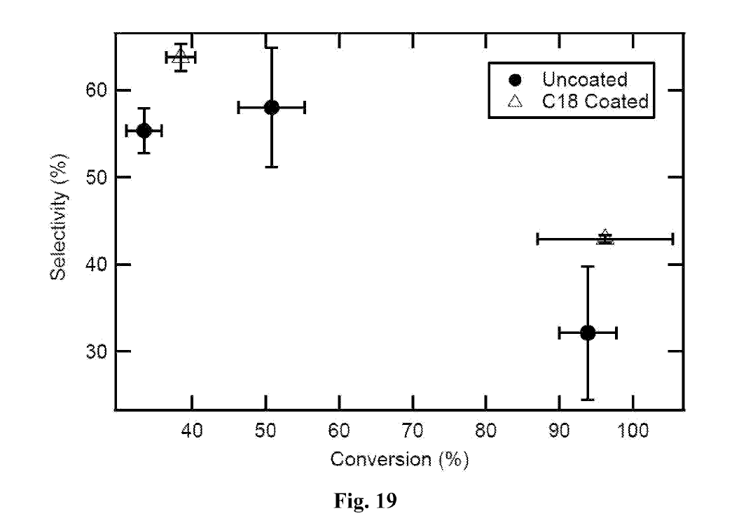

Additional experiments were conducted to check catalytic behavior after longer exposures to acetylene. In these experiments, coated and uncoated catalysts were exposed to reaction conditions for over 17 h. For these experiments, a single sample was used to produce each curve. Changes in conversion were therefore achieved by changing reactant flow rates while maintaining the same 5:1 H₂ to acetylene ratio. Selectivity enhancement was found to be roughly the same as those shown in FIG. 18 (as seen in FIG. 19).

A result of this work is that C18 SAM-coated samples were systematically found to enhance ethylene selectivity over uncoated samples. Interestingly, while the presence of the SAM coatings drastically inhibited ethylene hydrogenation, acetylene reaction rates were found to be equivalent on coated and uncoated catalysts, as shown in Table 1. Therefore, the enhancement gained in selectivity using the SAMs does not require the use of additional catalyst despite the presence of the thiols on the surface. Without being held to any particular theory, this result is potentially due to the presence of unreactive, strongly-adsorbed spectator species even on the uncoated Pd catalysts. For comparison, relative reaction rates for the hydrogenation of EpB are also shown in Table 1. For relatively “sticky” reagents such as acetylene and (to a lesser extent) EpB, reaction rates using SAM-coated catalysts can be competitive with rates using “uncoated” surfaces that in fact become coated by considerable quantities of spectators under reaction conditions. It should be noted that the reaction rate of EpB toward the desired epoxybutane product on the coated catalyst was only approximately a factor of two lower than on the uncoated catalyst, further demonstrating that the effects of SAMs on reaction rates depend strongly on the nature of the reaction.

In some embodiments, surface coking occurs readily on Pd catalysts during the hydrogenation of acetylene. The carbonaceous deposits that irreversibly adsorb to the surface can take on a number of forms including graphitic carbon, dissolved carbon, and metal-carbide species. The surface geometry as well as the electronic structure of the underlying metal are presumably altered by replacing these carbonaceous species with other deposits such as thiols. It was determined from the ethylene hydrogenation studies that the coatings significantly reduced the rate of ethane production from gas-phase ethylene when no acetylene was present in the feed. From this finding, close to 100% selectivity to ethylene would be expected during acetylene hydrogenation on coated surfaces, but selectivity, though improved, was well below 100% at high conversion. The complex mixture of species deposited on the surface from acetylene may contribute to this observed discrepancy. It is also possible that the SAMs prevent ethane formation from gas phase ethylene species without inhibiting direct ethane formation from acetylene.

### Example 12

### DRIFTS Spectra for Ethylene and Acetylene Hydrogenation

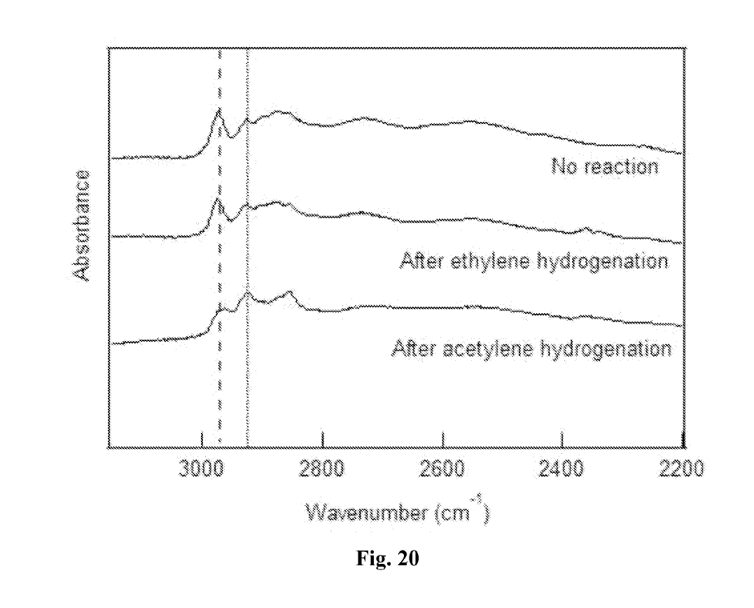

Diffuse reflectance infrared Fourier transform spectroscopy (DRIFTS) was conducted on C-18 samples to ensure SAMs were intact both before and after ethylene and acetylene hydrogenation. Samples were exposed to reaction conditions for over three hours. Spectra for these samples are shown in FIG. 20. The characteristic C—H stretching modes for well-ordered SAMs are found between 2800-3000 cm⁻¹ on polycrystalline Pd surfaces. The major peaks associated with the asymmetric methylene stretch (2921 cm⁻¹) and the asymmetric methyl stretch (2966 cm⁻¹) were observed, indicating the presence of intact SAMs before and after exposure to reactants for over three hours. Differences in relative peak intensity after acetylene hydrogenation were noted, however, which may indicate some amount of SAM degradation after exposure to acetylene. In contrast, the DRIFTS spectra collected after ethylene hydrogenation shows little evidence for changes in the SAMs.

### Example 13

### Methods for Liquid Phase Catalysis

Preparation of Supported Metal Catalyst:

The supported metal catalyst, Palladium supported on Alumina (Pd/Al₂O₃), was purchased from Sigma Aldrich as a stock material. This Pd/Al₂O₃ was supported between two layers of glass wool in a gas flow reaction tube and placed in a heater. In this setup, the catalyst was first oxidized under flowing conditions of 20 sccm O₂ dilute with 80 sccm He for 3 hours at 300° C. Next, the temperature was decreased to 200° C. and the catalyst was reduced for 2 hours under flow conditions of 20 sccm H, dilute with 80 seem He. This catalyst was then cooled under flowing He. At this point, the catalyst can either be used as an uncoated catalyst or can be coated with a self-assembled monolayer.

Preparation of Self-Assembled Monolayer:

To prepare the SAMs, the oxidized and reduced Pd/Al₂O₃ is left in the oxidizing and reducing glass reaction tube, is sealed at the bottom, and immersed in an alkanethiol solution of 1-10 mM solution of ethanol for 12-48 hours. The C-18 octadecanethiol was prepared as a 1 mM solution while the thioglycerol and other monolayers were prepared from a 10 mM solution. After deposition, the excess ethanolic solution is poured off and the reaction tube is dried under flowing helium.

In some embodiments of the liquid phase system, exposure to air can compromise the structure of the SAMs on the catalyst surface. This exposure is hard to avoid considering the preparation system being separate from the reaction system. Previous work used XPS to reveal that the palladium-sulfide interphase at the surface of the palladium SAMS are stable in air and that the sulfur on the surface oxidizes in 2-5 days at room temperature (Love et. al., JACS, 125, 2597-2609, (2003)).

Surface Characterization:

Characterization of the SAM surface was performed as in (Love et. al., JACS, 125, 2597-2609, (2003)), which is herein incorporated by reference. Ellipsometry, spectroscopy, and other techniques were used to describe the structure and organization of alkanethiols on Pd. In some embodiments, the goal of infrared reflection-absorption spectroscopy of surface species is to measure infrared spectra of monolayer and sub-monolayer dispersion. Both dispersive and FTIR techniques can yield good spectra of adlayers on low-area metal surfaces at monolayer and submonolayer coverages. FTIR is used to characterize the order of the SAMs on the catalyst surface by their characteristic vibrational frequencies. Chemisorption of hydrogen is used to identify the number of active surface sites on the catalyst surface as a way to standardize the catalyst activity as a function of known active sites per mass of catalyst.

Liquid Phase Reaction System:

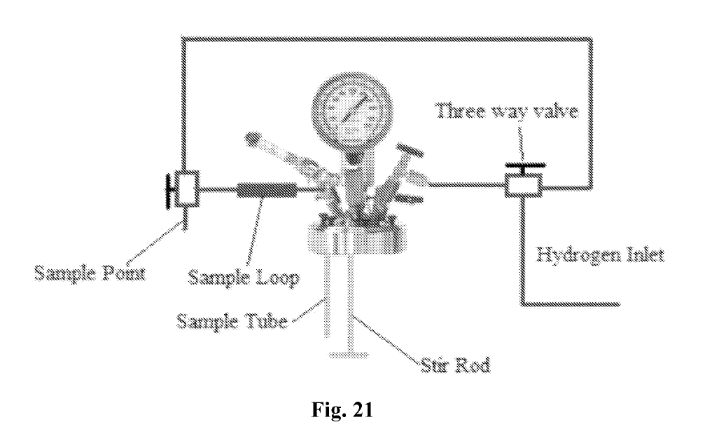

Described herein is operation of a liquid phase reactor (e.g., FIG. 21). Liquid phase reactions are run in a dilute solvent phase and are run to completion in a batch process. Prepared catalyst is sealed in a Parr 100 mL reaction vessel with the appropriate liquid system. The liquid solvent, typically heptane or ethanol is added at 48 mL along with 5 mL of internal standard THF and 1 mL of liquid reactant, typically epoxybutene or another multifunctional oxygenate such as an α,β-unsaturated aldehyde. This dilute system is used to enhance the accuracy of reactant measurements and to minimize the materials costs. The sealed reactor is pre-heated to between 30° C. and 60° C. and when the temperature is stable, the system is pressurized under hydrogen gas up to 6 bar. This introduces reactant to the system and starts the reaction. Samples are taken from the reaction system at increasing intervals of 0, 2, 5, 10, 19, 30, 50, and 90 minutes so that a range of conversion can be measured in the reactor. These samples are obtained with the sampling apparatus shown in FIG. 21 where internal hydrogen pressure forces a liquid sample through a filter and re-pressurization forces excess liquid back into the reactor. These liquid samples are then analyzed by gas chromatography with a flame ionization detection system to measure what concentrations of reactants and products are found in the reaction system. The responses of each reactant or product were analyzed as a ratio to the internal standard so the molarity of each component could be calculated and analyzed.

### Example 14

### Inclusion of Thioglycerol in Liquid Phase Catalysis

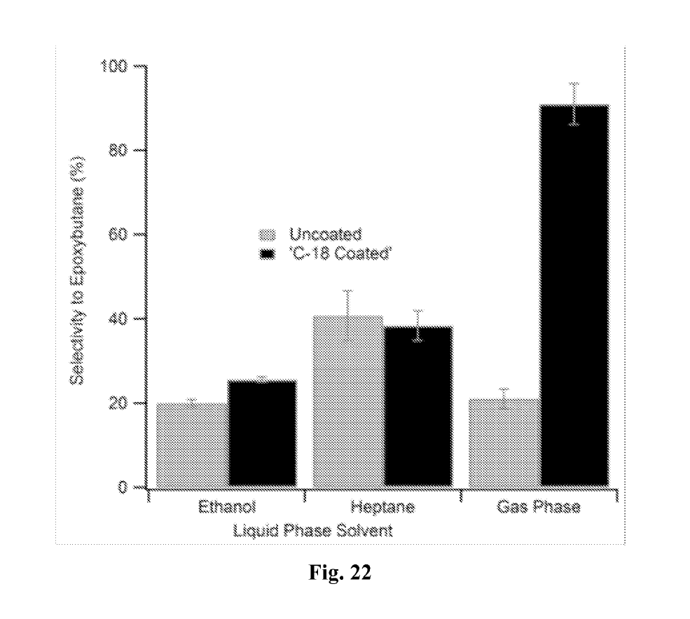

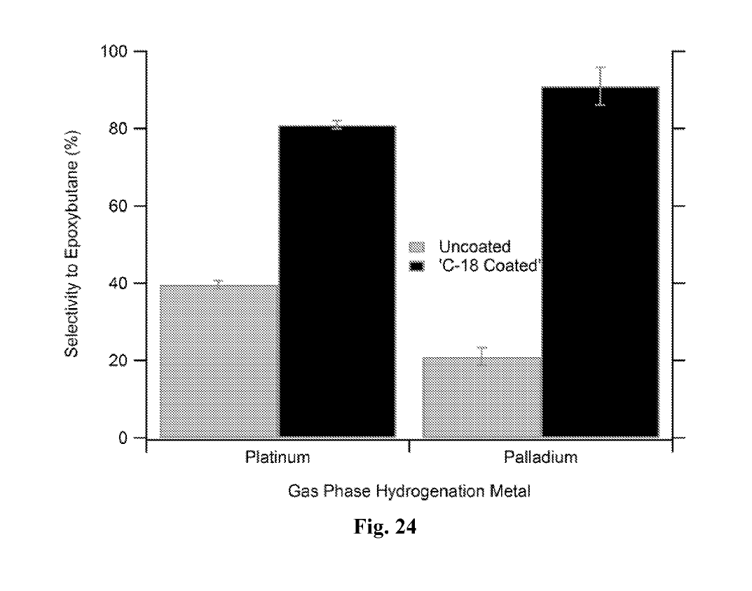

SAM catalysis was conducted in both the gas (e.g., FIG. 24) and liquid phases. EpB was first hydrogenated in the gas phase with an uncoated palladium catalyst and an octadecanethiol coated palladium catalyst as described herein. Hydrogenation of EpB was then performed in the liquid phase with the same uncoated and octadecanethiol coated palladium catalysts with solvents of ethanol and heptane. Exemplary results are shown in FIG. 22. It was unexpectedly found that there was no pronounced effect of selectivity between the coated and uncoated cases in the liquid phase. The difference in selectivity for the ethanol solvent was 5% while the difference between coated and uncoated reaction in heptane was only 3%. While these differences in selectivity were still determined to be statistically significant, they were far less than the effect seen in the gas phase, which was more than a 70% difference. In addition, each of the two liquid phase solvents led to contrasting selectivity; the coated and uncoated heptane both saw selectivity to epoxybutane of about 40% while ethanol was only 20%.

The initially studies were performed in ethanol solvent and octadecanethiol as a representative polar solvent and non-polar coating. After testing the system with heptane, a new coating of thioglycerol was tested, in part to probe contrasting polarities of solvent and coating. As seen in FIG. 22 this led to a dramatic shift in the selectivity where the heptane and thioglycerol case saw selectivity of greater than 80% compared to 40% for the uncoated case.

Thioglycerol is insoluble in heptane at typical reaction conditions. In contrast, each of the other SAM coated systems had measurable solubility in the solvent phase. For example in these embodiments, each of the SAM coatings is deposited from an ethanol solution, so each of these systems has inherent solubility in the bulk phase.

In addition to the specific implementations explicitly set forth herein, other aspects and implementations will be apparent to those skilled in the art from consideration of the specification disclosed herein. It is intended that the specification and illustrated implementations be considered as examples only.

1. A supported metal catalyst comprising sulfur and/or selenium on the surface of the metal, wherein at least 70% of the sulfur and/or selenium is in the (√3×√3)R30 geometry.

2. The catalyst of claim 1, wherein at most 10% of the sulfur and/or selenium is in the (√7×√7)R19 geometry.

3. The catalyst of claim 1, wherein the sulfur and/or selenium is bound to a hydrocarbon tail.

4. The catalyst of claim 1, wherein the sulfur and/or selenium is coated on the surface of the metal as substantially a self-assembled monolayer (SAM).

5. The catalyst of claim 1, wherein the sulfur and/or selenium covers at least 80% of the surface of the metal.

6-25. (canceled)

26. A supported metal catalyst comprising a selectivity agent, wherein the catalyst is capable of
a. selectively hydrogenating an olefin at a yield of at least 60%; and
b. hydrogenating the olefin with a turnover frequency of at least 40% when compared with the turnover frequency with the metal catalyst without the selectivity agent.

27. The catalyst of claim 26, wherein the selectivity agent comprises a hydrocarbon tail and at least one of a thiol, a selenide, a disulfide, and a diselenide.

28. The catalyst of claim 26 wherein the selectivity is measured in the gas phase.

29. The catalyst of claim 26 wherein the selectivity is measured in the liquid phase.

30. A supported metal catalyst comprising an alkanethiol self-assembled monolayer, wherein the catalyst is capable of selectively hydrogenating acetylene in a mixture of acetylene and ethylene.

31. The catalyst of claim 30, wherein the mixture of acetylene and ethylene comprises between about 0.5% and 3% acetylene.

32. The catalyst of claim 30, wherein the catalyst is capable of reducing the acetylene concentration to less than 5 ppm in the mixture.

33. The catalyst of claim 30, wherein the ethylene is not substantially hydrogenated to ethane.

34. The catalyst of claim 30, wherein the selective hydrogenation of acetylene is capable of being achieved without addition of carbon monoxide to the mixture.

35. The catalyst of claim 30, wherein the alkanethiol comprises at least 18 carbon atoms.

36. The catalyst of claim 30, wherein the activity of the supported metal catalyst comprising an alkanethiol self-assembled monolayer for acetylene hydrogenation is at least 80% of the activity of the supported metal catalyst without the alkanethiol self-assembled monolayer.

37-73. (canceled)
